(19) United States
(12) Patent Application Publication
(10) Pub. No.: US 2005/0033822 A1
(43) Pub. Date: Feb. 10, 2005

(54) Method and apparatus for information distribution and retrieval

(76) Inventors: George Dale Grayson, Parker, TX (US); Wallace Walker Lowery IV, Allen, TX (US); Daniel Joseph Kuenster, Los Angeles, CA (US); Robert J. Rubin, Dallas, TX (US); William August Fahle JR., Plano, TX (US); John Anthony Schnurrenberger, Dallas, TX (US)

Correspondence Address: SLATER & MATSIL, L.L.P., 17950 PRESTON RD, SUITE 1000, DALLAS, TX, 75252-5793, US

(21) Appl. No.: 10/634,609

(22) Filed: Aug. 5, 2003

(51) Int. Cl. G06F 15/16

(52) U.S. Cl. 709/217

(57) ABSTRACT

A system and method for information distribution and retrieval. A preferred embodiment comprises downloading information, such as data, an application, and the like, from a server to a client. The information may be distributed to other clients without the need of a network connection to the server. Furthermore, modifications to the information made by the client may be distributed to other clients and the server. In another embodiment, the present invention downloads segments on an as needed basis. The segments may be reusable to provide further benefits. A relatively small application utilizes the reusable segments and an activity graph to perform specific functions.

### TECHNICAL FIELD

The present invention relates generally to a system and method for information distribution and retrieval and, more particularly, to a system and method for distributing and retrieving information from a local peer and a remote application server.

### BACKGROUND

Networks, such as the Internet, local-area networks, wide-area networks, and the like, have become common methods to distribute and provide goods and services to users. Generally, networks connect users to each other and to a central server or servers. The users may either be local users or geographically dispersed users. Organizations typically operate one or more servers for providing or distributing goods and services to users. The goods and services may range from software applications, data retrieval, on-line games, and the like.

Communications between a user and the central servers and between different users are generally limited by the bandwidth of the links and the technologies being utilized to communicate. Developments have been made to improve or increase the bandwidth available to a user. However, the bandwidth requirements necessary to satisfactorily support new applications are steadily increasing. For example, while cable modems and digital subscriber lines (DSL) generally increase bandwidth available to the user as compared to a 14.4 or 28.8 kbps modem, the increased bandwidth is not sufficient to support some applications. Furthermore, many users do not have access to the higher bandwidths.

Some applications, particularly interactive applications, typically require readily accessible bandwidth for the application to provide a response within a satisfactory period of time. For example, a user connected to a network or application server via a 14.4 kbps modem or via a shared connection, may not have enough bandwidth available for the application to function satisfactorily, resulting in significant delays of the application responding to user input.

Thus, there is a need for a method and apparatus of providing goods and services via a network that reduces bandwidth requirements.

### SUMMARY OF THE INVENTION

These and other problems are generally solved or circumvented, and technical advantages are generally achieved, by preferred embodiments of the present invention which provides a method and apparatus for information distribution and retrieval. In accordance with one embodiment of the present invention, a method and an apparatus for distributing information is provided. The method includes downloading a client application to a client. The client application determines which resources are needed to perform and retrieves a subset of the resources required by the client application. The information may be, for example, an interactive application. The client application retrieves the resources, such as, for example, graphics files, audio files, and the like, in groups such that the client application is not required to retrieve all of the resources at once.

In another embodiment, the present invention provides an interactive application on a client. The client application is downloaded to a client from an application server. Scenes are defined that indicate resources that are required to perform. The scenes may refer to such things as assets, asset bags, graphics files, audio files, and the like. The client application retrieves the scenes and the objects identified by the scene. The client application retrieves the resources from another client if available, or from the application server if the resource is not available on a client. The logic flow of the client application is defined by an activity graph, which defines the scope and sequence of activities.

In yet another embodiment of the present invention, a method and an apparatus of performing a client application is provided. A sequence of activities is defined. The sequence is traversed to determine which activities and resources may be required by the client application after a current activity completes. The client application retrieves those resources in preparation of performing those activities.

In yet another embodiment of the present invention, a method and an apparatus of providing an application is provided. A client application is downloaded to a client, and a knowledge base is maintained on an application server. A portion of the knowledge base that is required for the client application and a specific user is downloaded and maintained on the client. Updates to the knowledge base are provided by the client to the application server.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 is a network diagram embodying features of the present invention;

FIG. 2 is a network diagram embodying features of the present invention;

FIG. 3 is a data flow diagram illustrating steps to initiate a client application in accordance with one embodiment of the present invention;

FIG. 4 is a block diagram illustrating the components of a client application in accordance with one embodiment of the present invention;

FIG. 5a is a block diagram illustrating the contents of an asset bag in accordance with one embodiment of the present invention;

FIG. 5b is a block diagram illustrating the contents of a scene in accordance with one embodiment of the present invention;

FIG. 6 is a data flow diagram illustrating the steps that may be performed to retrieve resources in accordance with one embodiment of the present invention;

FIG. 7 is a data flow diagram illustrating the steps that may be performed to update the client application in accordance with one embodiment of the present invention;

FIG. 8 is a data flow diagram illustrating the steps that may be performed to retrieve a knowledge base in accordance with one embodiment of the present invention;

FIG. 9 is a data flow diagram illustrating the steps that may be performed to provide application services in accordance with one embodiment of the present invention;

FIG. 10 is a data flow diagram illustrating the steps that may be performed to predict and retrieve resources in accordance with one embodiment of the present invention;

FIG. 11 is a data flow diagram illustrating the steps that may be performed to store data in a knowledge base in accordance with one embodiment of the present invention;

FIG. 12 is a data flow diagram illustrating the steps that may be performed to determine which activity a user should perform in accordance with one embodiment of the present invention;

FIG. 13 is a data flow diagram illustrating the steps that may be performed to provide an application to a user in accordance with one embodiment of the present invention;

FIG. 14 illustrates the components of an activity graph in accordance with one embodiment of the present invention;

FIGS. 15a and 15b illustrate an activity graph and node definitions, respectively, in accordance with one embodiment of the present invention;

FIG. 16 illustrates an example of an activity graph in accordance with one embodiment of the present invention;

FIG. 17 illustrates an example of an activity graph in accordance with one embodiment of the present invention;

FIG. 18 is a message flow diagram illustrating messages that allow a client to join a group of clients in accordance with one embodiment of the present invention;

FIG. 19 is a message flow diagram illustrating messages transmitted or received by a client to synchronize a knowledge base and activity graph definition in a network environment in accordance with one embodiment of the present invention; and

FIG. 20 is a message flow diagram illustrating messages transmitted or received by a client to retrieve assets in accordance with one embodiment of the present invention.

### DETAILED DESCRIPTION OF ILLUSTRATIVE EMBODIMENTS

The making and using of the presently preferred embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

The present invention will be described with respect to preferred embodiments in a specific context, namely an interactive educational application. The invention may also be applied, however, to other applications such as game applications, software distribution, training applications, and the like.

It is further noted that, unless indicated otherwise, all functions described herein may be performed in either hardware or software, or some combination thereof. In a preferred embodiment, however, the functions are performed by a processor such as a computer or an electronic data processor in accordance with code such as computer program code, software, and/or integrated circuits that are coded to perform such functions, unless indicated otherwise.

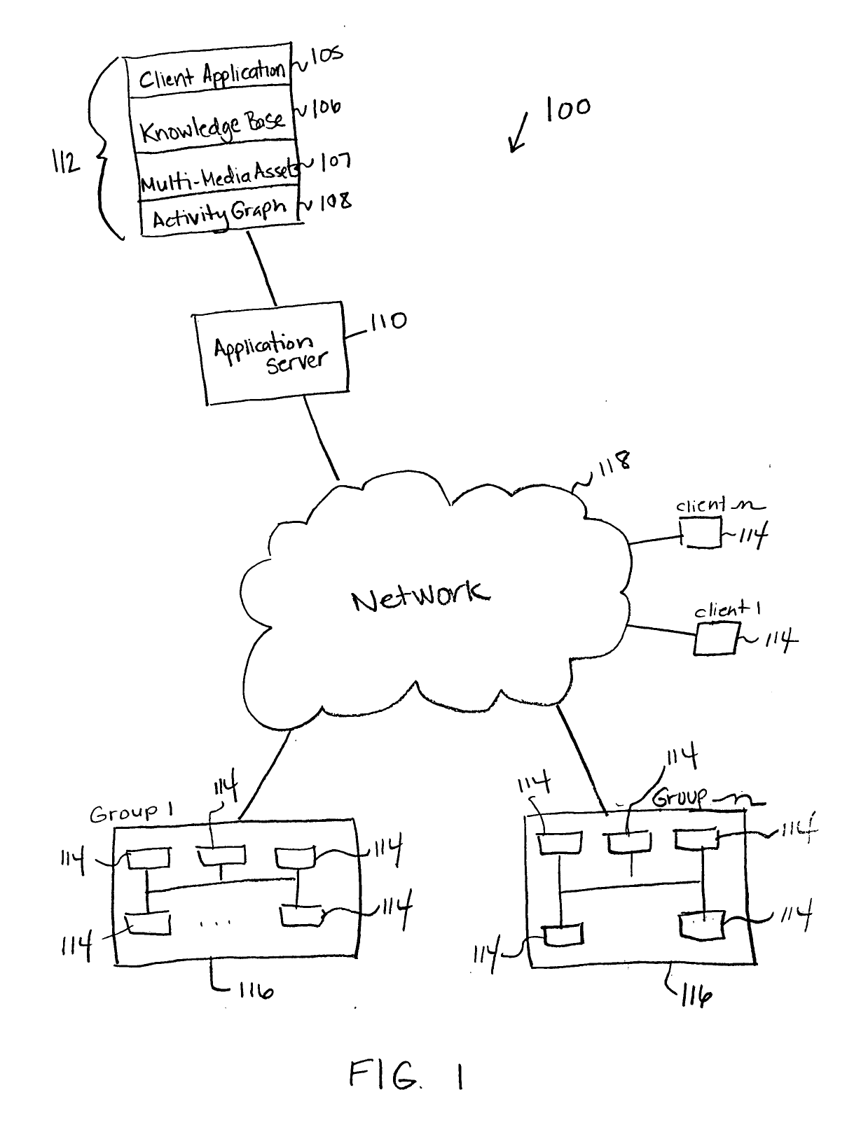

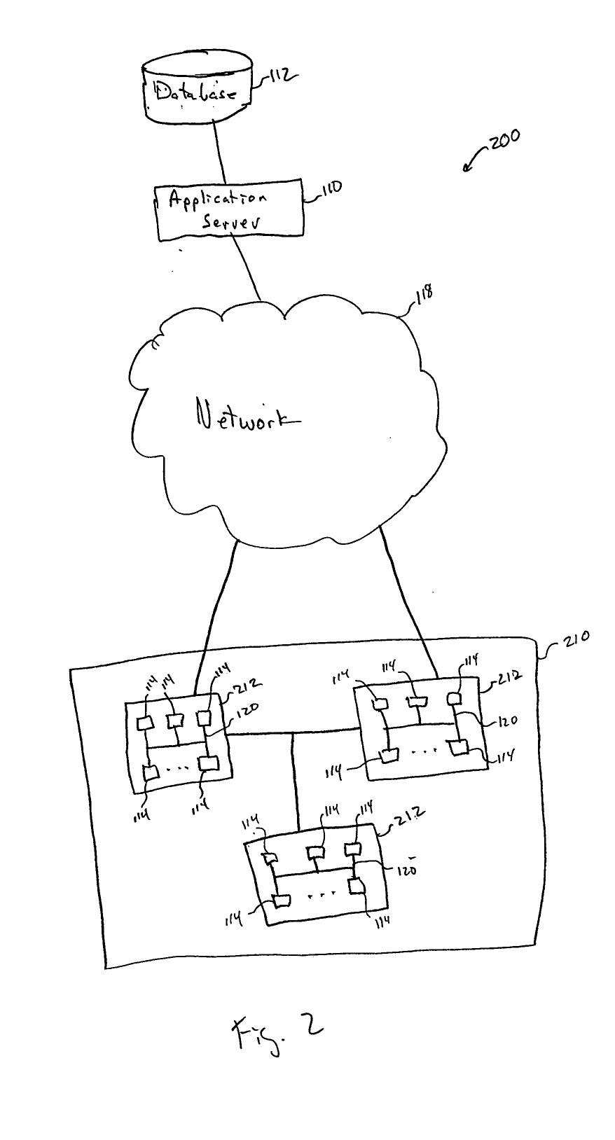

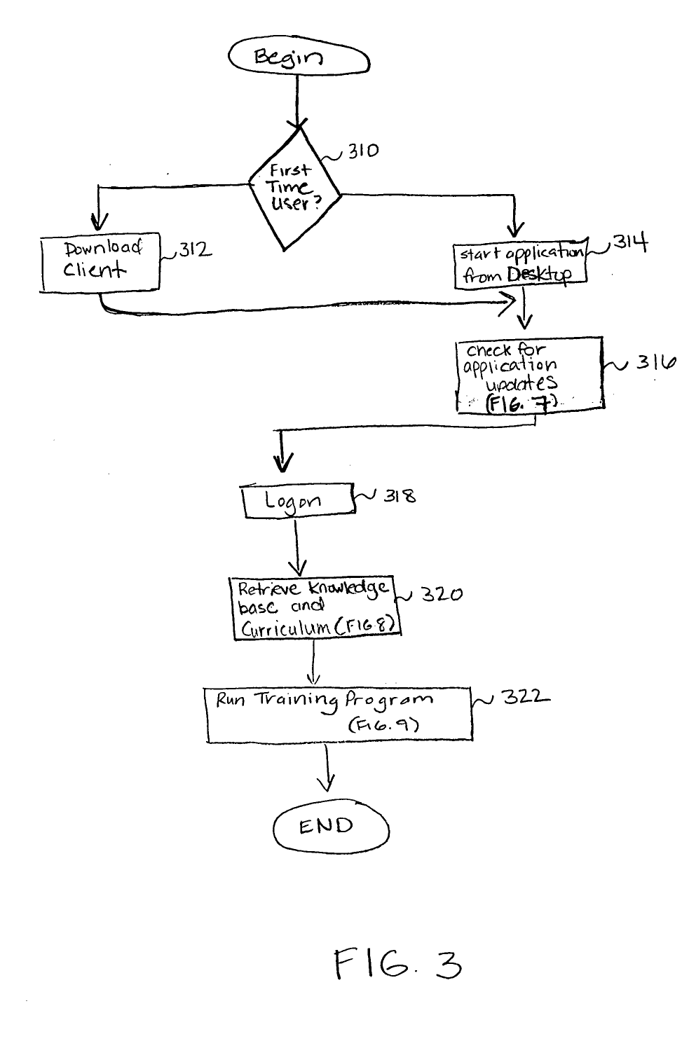

In the description that follows, FIGS. 1-2 show illustrative network environments embodying features of the present invention, and FIGS. 3-20 show illustrative aspects of the present invention in which a distributed application is implemented in a network environment in accordance with embodiments of the present invention. Generally, as the description that follows describes, the distributed application comprises a client application that is downloaded from a server to one or more client machines. The client application thereafter controls the download of data files on an as needed basis, wherein the data files define the logic flow of the client application and how the client application presents information to a user. The data files downloaded may be, for example, logic flows, audio files, bitmaps, JPEG files, MPEG files, scripts, and the like.

Referring now to FIG. 1, reference numeral 100 designates a network diagram embodying features of one embodiment of the present invention. An application server 110 is communicatively coupled to a database 112 and one or more clients 114 and groups of clients 116 (referred to hereinafter as “groups 116”). Preferably, the application server 110 is communicatively coupled to the clients and groups of clients via a network 118. The network 118, such as the Internet, a local-area network (LAN), a wide-area network (WAN), Public-Switched Telephone Network (PSTN), wireless communications network, or the like, provides communication services between the application server 110 and the clients 114 and groups of clients 116. The clients 114 and groups 116, however, may be directly connected to the application server 110 via a direct connection or a dial-up connection.

The clients 114 may be any suitable access device such as wireline phone, wireless phone, laptop computer, desktop computer, tablet personal computer, Personal Data Assistant (PDA), or the like. It is noted that a user (not shown) operates the clients 114, and accordingly, clients 114 include a user providing input to the clients 114 and receiving output from the clients 114. The clients 114 are configured to provide network access to the application server 110 and to perform the functions described herein.

Preferably, a plurality of clients 114 may be grouped together to form groups 116, as illustrated by the clients 114 located within the group 116. In the preferred embodiment, the clients 114 within the groups 116 are communicatively coupled together via a group network 120, such as by a LAN, WAN, PSTN, wireless communications network, or the like, and communicatively coupled to the network 118. Furthermore, it is preferred that each client 114 of the group 116 have a link to the network 118, or a plurality of clients 114 in the group 116 may share a link to the network 118. The group network 120 may include a group server (not shown).

The database 112 may include a client application 105, a knowledge base 106, one or more multi-media assets 107, and an activity graph 108. The database 112 may be a relational database, such as an Oracle database, an Informix database, a Sybase database, a DB2 database, or the like, a text file, a binary data file, some combination thereof, or the like, configured to store user information and application information.

The client application 105 is preferably a software application that is written in a portable software language and downloaded as either one or more executables or as one or more code modules. Alternatively, the client application 105 may be a document, a series of documents, viewer files, or the like. For example, the client application may be an executable module obtained from compiling and building a software program written in Visual BASIC, Visual C++, C, C++, or the like. Alternatively, the client application may be a program written in an interpretive language such as Java, hyper-text markup language (HTML), extended markup language (XML), or the like that is downloaded and executed as source code. In the preferred embodiment, however, a language that compiles to native code, such as C++, is used. However, a portable language, such as JAVA, that has been modified to remove features and capabilities that are not required by the application is utilized in the role of a script language. A script language allows instructions to be performed that are easier to update than instructions in a native executable. In this manner, the size of the client application may be further reduced. Additionally, it may be desirable to separate the client application into one or more downloadable portions. In particular, separate downloadable portions may be particularly useful for large applications by reducing the download time and the space required on the clients 114.

The knowledge base 106 represents the user-specific data regarding the use of the system by a specific user or a specific group of users. In one embodiment in which the present invention is utilized for an automated teaching system, the knowledge base 106 contains detailed information regarding lessons performed by each student, the results of assessments, the attempts made by each student for each lesson, and the like. Furthermore, the knowledge base 106 may optionally include subscription information that indicates which goods and services a particular client 114 or group 116 may access and subscriber information that indicates the status of a client 114 or a group 116.

The multi-media assets 107 define how objects are to be presented to the user, such as presenting objects to the user via audio, graphics, a combination thereof, or the like. The multi-media files may be, for example, a bitmap file, a JPEG file, an MPEG file, a picture file, an audio file, or the like.

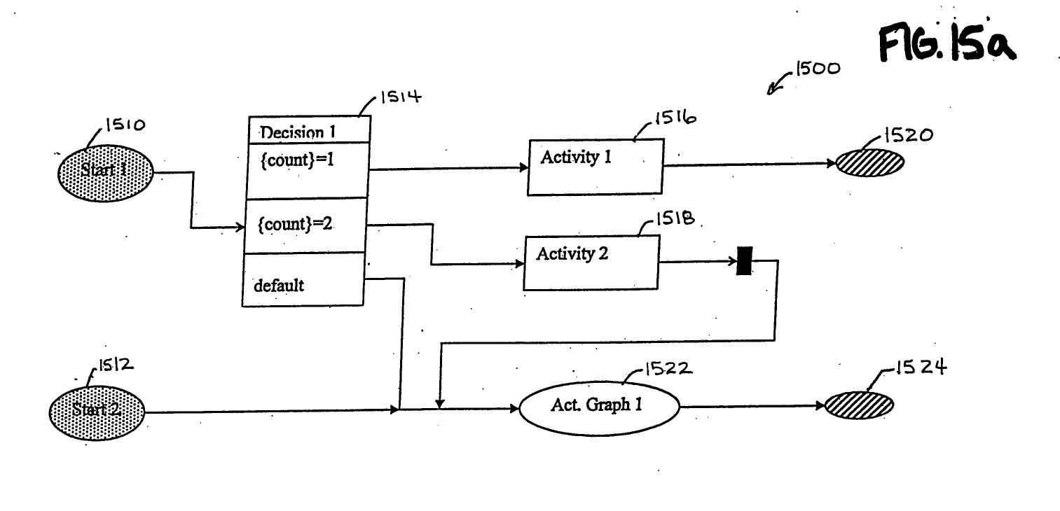

The activity graph 108 defines the activities and the sequence of a curriculum, such as activities in which the user is expected to partake. Generally, the activity graph 108 includes a series of nodes and relationships between those nodes. The nodes define an activity or action and the relationship between the nodes represents the sequence of nodes. The activity graph 108 is preferably designed to apply to groups of users such as a class, first graders, and the like. The activity graph 108 will be discussed in greater detail below with reference to FIGS. 14-17.

The details of the client 114, the application server 110, the knowledge base 106, the client 114, the group 116, and the network 118 are well known to a person of ordinary skill in the art and, therefore, will not be discussed in further detail, except to the extent necessary to enable one of ordinary skill in the art to make and use the present invention.

FIG. 2 is a network diagram in which reference numeral 200 designates a network environment embodying features in accordance with one embodiment of the present invention, wherein like reference numerals refer to like elements in FIG. 1. In this scenario, a group 210 includes subgroups 212, wherein each subgroup 212 may have one or more clients, such as clients 114. Each client 114 of each subgroup 212 is preferably connected to a group network 120 as described above. In addition, however, each subgroup 212 is communicatively coupled to one or more other subgroups 212. In the preferred embodiment, each subgroup 212 is communicatively coupled to each of the other subgroups 212 via a wide-area network or the like. Most preferably, each client 114 of each subgroup 212 is communicatively coupled to clients 114 contained in other subgroups 212.

For example, many school districts provide students, faculty, and administrators with computers configured to access a network such as the Internet. Within a school, such as an elementary, middle, or high school, computers are typically connected to a LAN, thereby providing access to other computers within the school. Furthermore, the computers are frequently able to gain access to clients or servers located in other schools, such as another elementary school within the same or different school district. Many times, a dedicated link is provided between schools.

FIG. 3 is a data flow diagram illustrating steps that may be performed to initiate use of a distributed application in accordance with one embodiment of the present invention. Generally, as will be discussed in detail below, the client application 105, which is relatively small as compared to the entire database 112, is downloaded from the application server 110 to the client 114. The client application 105 controls the downloading of other files, such as the assets, asset bags, scenes, and the like, and interprets those files to control the logic flow and to define a user interaction.

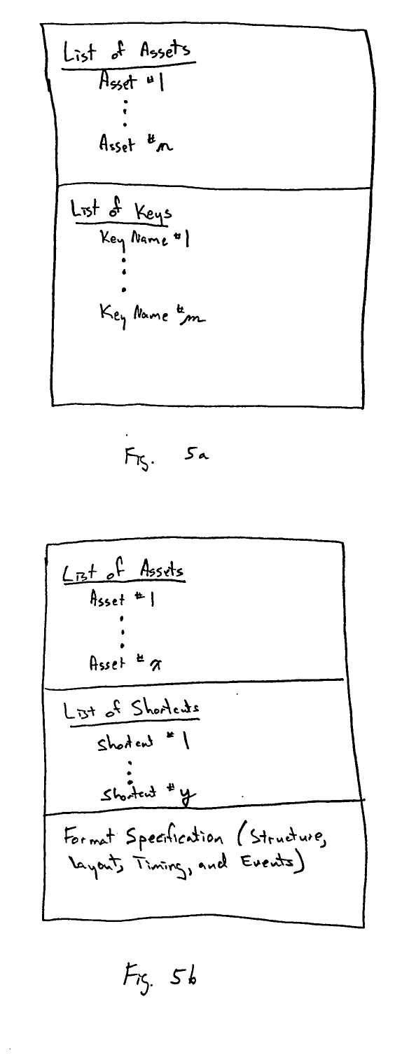

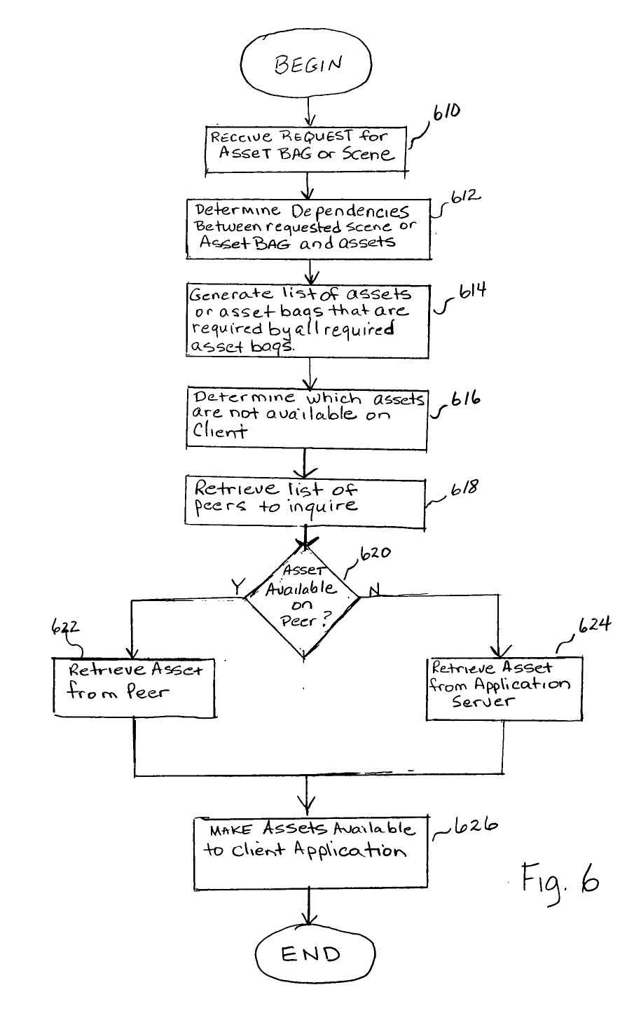

Asset bags are preferably static data structures that define individual features, referred to as assets, of an object, e.g., appearance, sound, and the like, of an object, such as an animated character, a background object, or the like. As will be explained in greater detail below, each feature of an object may have one or more appearances. For example, the mouth of a character may have different positions or shapes to correlate to the phrase being said by the character. The various features of the object may be pieced together to form various unique combinations. Scenes, on the other hand, define the user interaction. Scenes may refer to one or more assets, asset bags, and combinations of the assets and asset bags to create unique scenes for the user. The asset bags and scenes are discussed in greater detail below with reference to FIGS. 5a and 5b.

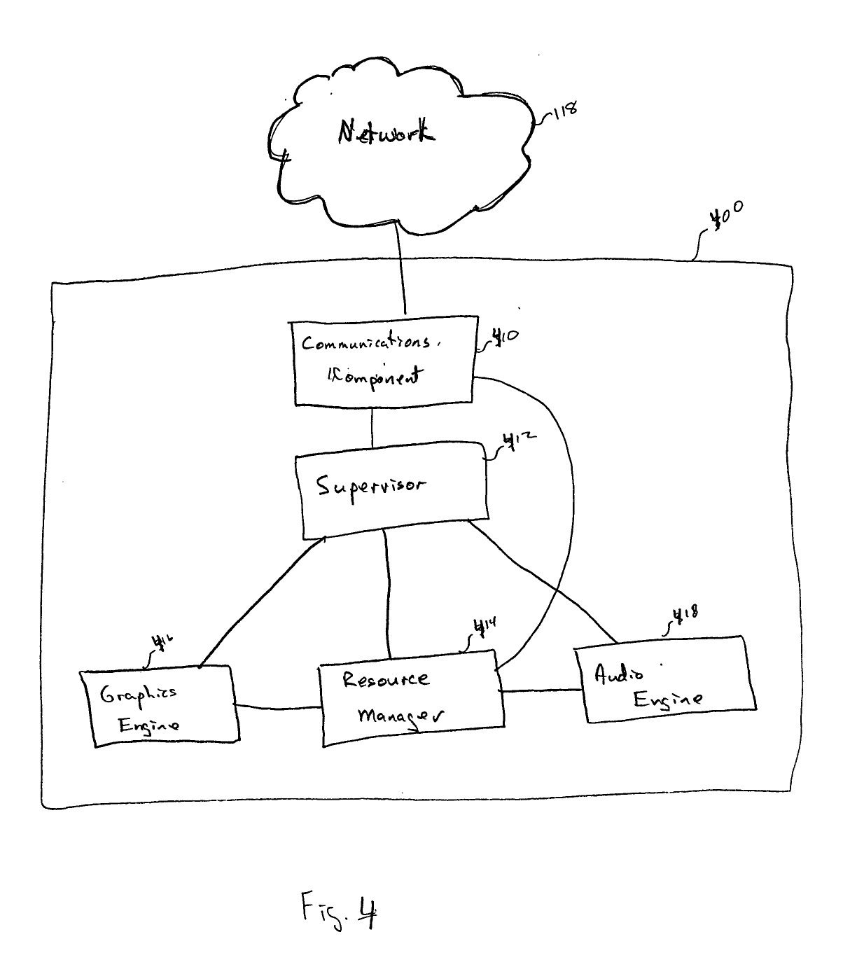

Processing begins in step 310, wherein a determination is made whether or not the user of a client 114 (see e.g., FIGS. 1-2) is a first time user. If a determination is made that the user is a first time user, then processing proceeds to step 312 wherein the client application 105 (FIG. 1) is downloaded. Generally, the client application is a generic application that controls the logic flow of the application in response to user input. Upon downloading the client application 105, the client application 105 is installed on the client, and thereafter is accessible from the desktop of the client without requiring another client application download. The client application is discussed in greater detail below with reference to FIG. 4.

If, in step 310, a determination is made that the user is not a first time user, then the processing proceeds to step 314, wherein the client application 105 is initiated from the desktop. By downloading the client application 105 to the desktop, the application is readily available regardless of whether access is available to the application server 110. Furthermore, the response time of the client application 105 will be significantly enhanced because the need to request information from the application server 110 is significantly reduced.

In step 316, the client checks for updates to the client application 105. It is noted that this step does not necessarily need to be performed if the client application was previously downloaded in step 312, but will ensure that the client 114 has the latest application updates in the case when the application server 110 pushed an application update to the clients when one or more of the client machines were unavailable or when the application server 110 updates the client application 105 via the use of patches or modifications to the base client application 105 load.

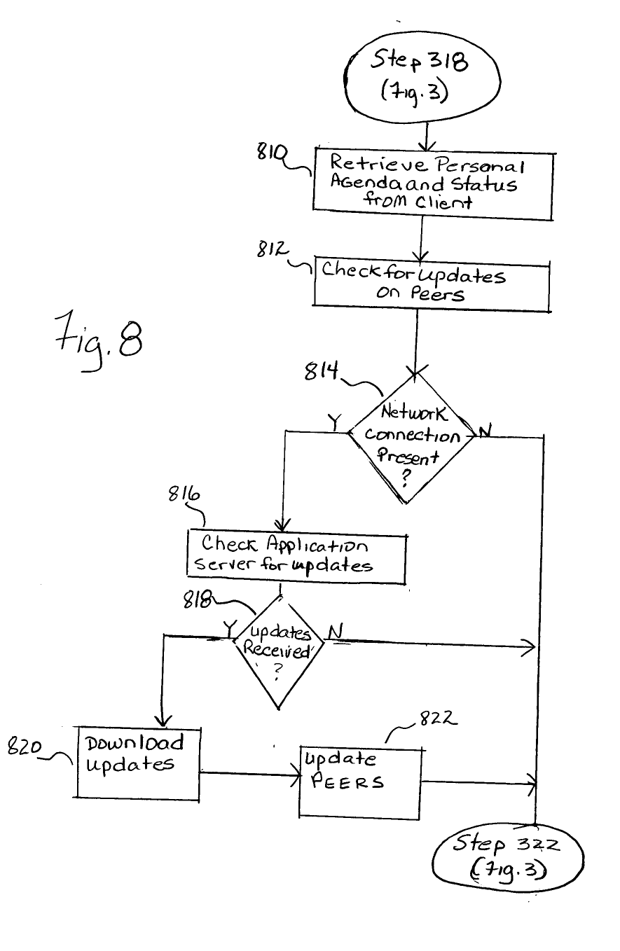

Preferably, the client application 105 queries other clients (i.e., peers) and the application server 110 for updates to the client application 105. If updates to the client application 105 are available, the client downloads and installs the updates. It is noted that by utilizing the framework described herein, the size of the client application is kept at a minimum, thereby reducing the amount of time required to download and install updates to the client application, if any. Preferably, updates are made to the scenes and asset bags, which are downloaded on an as needed or an as predicted need basis. The process of checking for client application updates is described in greater detail below with reference to FIG. 7.

After downloading the client application in step 312 or initiating the client application 105 from the desktop in step 314, processing proceeds to step 318 wherein the user logs onto the client application 105. Preferably, the client application 105 tracks the progress of each individual user and customizes the client application 105 in accordance with the past performance of the user, needs of the user, user selections, and the like. Accordingly, a unique logon is preferably provided to identify and track the progress of each user.

In step 320, the knowledge base 106 and activity graph 108 of the user are retrieved. As discussed above, the knowledge base 106 includes a curriculum or topics in which the user is interested, status or progress indicator of the user, cumulative performance information regarding how the student performed in a particular subject or on a particular lesson, and the like, and the activity graph 108 defines the activities and sequence of activities that are to be performed by a user or a group of users.

Furthermore, it is desirable, particularly in large applications, that the knowledge base 106 and activity graph 108 be retrievable in portions. Initially, the portions that are required to begin execution of the application are downloaded. Later, preferably in the background, additional portions of the knowledge base 106 and activity graph 108 may be retrieved on an as needed basis.

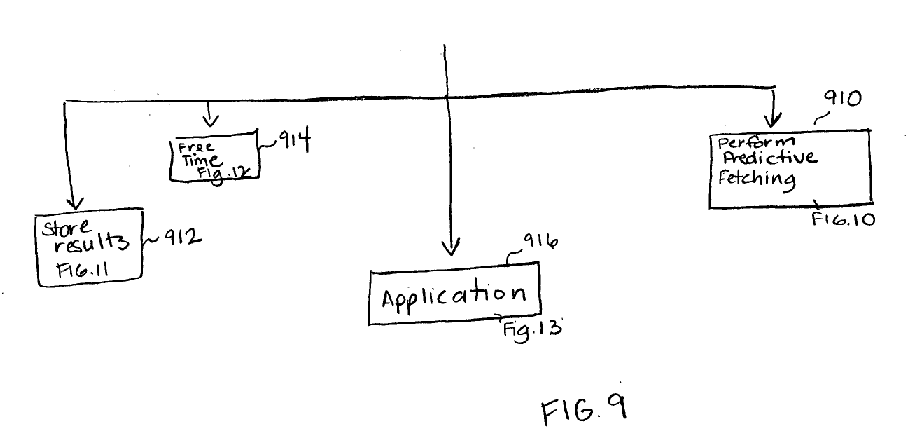

In a preferred embodiment such as a networked educational system, the curriculum may be the subjects to which the school subscribes, the topics a student is interested in or needs assistance, or the like. Furthermore, the knowledge base 106 may have updates stored on other client machines that have not been stored in the knowledge base 106. Thus, it is preferred that upon initiation the client 114 retrieves the latest information available from application server 110 and other clients. In this manner, a user may use various client machines and the client application 105 will automatically and seamlessly retrieve any available knowledge base updates. The retrieval of the knowledge base 106 of the user is discussed in greater detail below with reference to FIG. 8.

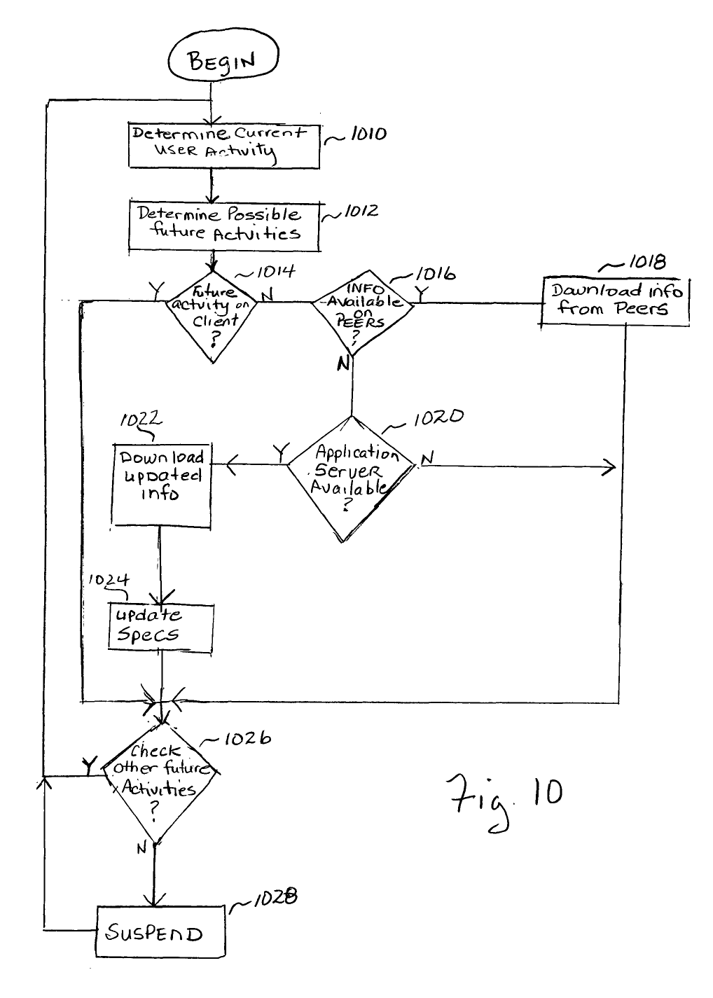

Thereafter, processing proceeds to step 322, wherein the client application 105 is performed. The process of performing the client application is discussed in greater detail below with reference to FIG. 9 in the context of an educational program for illustrative purposes only. As one of ordinary skill in the art will appreciate, however, the client application 105 may implement other types of systems, such as, for example, a document retrieval system, an on-line tutorial, and the like.

One of ordinary skill in the art will appreciate that the client application 105 and knowledge base 106 are preferably downloaded and/or updated once per session. As indicated above, this download and update processing is performed seamlessly prior to the user beginning to use the application. In this manner, the response time of the application is kept at a minimum. In alternative embodiments, the client application and/or the knowledge base 106 may be downloaded or updated in blocks as time permits or on an as-needed basis, preferably in the background prior to the time the blocks are needed by the user. These alternative embodiments are particularly useful when the client application 105 or knowledge base 106 is large, causing the user to wait a significant amount of time prior to using the application.

FIG. 4 shows a block diagram illustrating the structure of a client application 105 in accordance with one embodiment of the present invention. Preferably, the client application 400 is downloaded to the client 114 from the application server 110 (FIG. 1).

The client application 105 preferably comprises a communications component 410, a supervisor 412, a resource manager 414, a graphics engine 416, and an audio engine 418. Preferably, the components of the client application 105 are performed by a combination of executables generated in an object-oriented language and scripts generated in an interpretative language. In particular, the preferred embodiment utilizes C++ to generate executables to control the logic of the client application 105, communications, low-level device interactions, and the like. An interpretative language, such as Java (or a stripped-down version of Java), is used to format the presentation of the assets and asset bags to the user.

The communications component 410 interfaces with the supervisor 412, the resource manager 414, and the network 118 (communicatively coupled to the application server 110 (FIGS. 1 and 2)). The communications component 410 acts as a portal for communications between the client and the application server 110 or between the client and other clients.

Preferably, as will be described in greater detail below, the communications component receives from the supervisor 412 requests for information, such as activity graph definitions, and the like, and receives requests from the resource manager 414 for, as an example, assets, asset bags, scenes, and the like. The communications component formats the requests in a format required by the application server 110 and utilizes standard communications protocols to transmit the requests to the application server 110. The standard communications protocols may be, for example, Transmission Control Protocol/Internet Protocol (TCP/IP), a wireless protocol, or the like. In the preferred embodiment, the communications component 410 utilizes software components that are commonly provided with operating systems, such as Windows provided by Microsoft Corporation, to provide the lower-level communications via TCP/IP. Accordingly, in the preferred embodiment, the communications component 410 handles the application-level communications between the client 114 and the application server 110 and between multiple clients 114.

Similarly, the communications component 410 receives information from the application server 110 via the network 118. Upon receipt, the communications component 410 formats the received information in a format acceptable to the designated recipient of the information, i.e., the supervisor 412 and the resource manager 414.

The graphics engine 416 and the audio engine 418, collectively referred to as the multi-media engine, provides the interface and the capabilities for displaying graphics and playing audio sounds, respectively. Generally, the graphics engine 416 operates on the structural information embedded in scenes and asset bags, in addition to the bitmaps specified as assets in those scenes and bags, to present an animated graphical interface, such as is present in many games. The audio engine 418 takes timing and structural information from scenes and asset bags, as well as the audio files and/or text files specified in the scenes and bags, and/or text input from the user, and plays sounds. Preferably, the text files and text input are played using a text-to-speech portion of the audio engine, and audio files are played using the operating system services. The structural information from the scenes and bags can include timing information, other modifying information that changes the way the bitmaps are displayed, or the audio is played (e.g., fading out, etc.).

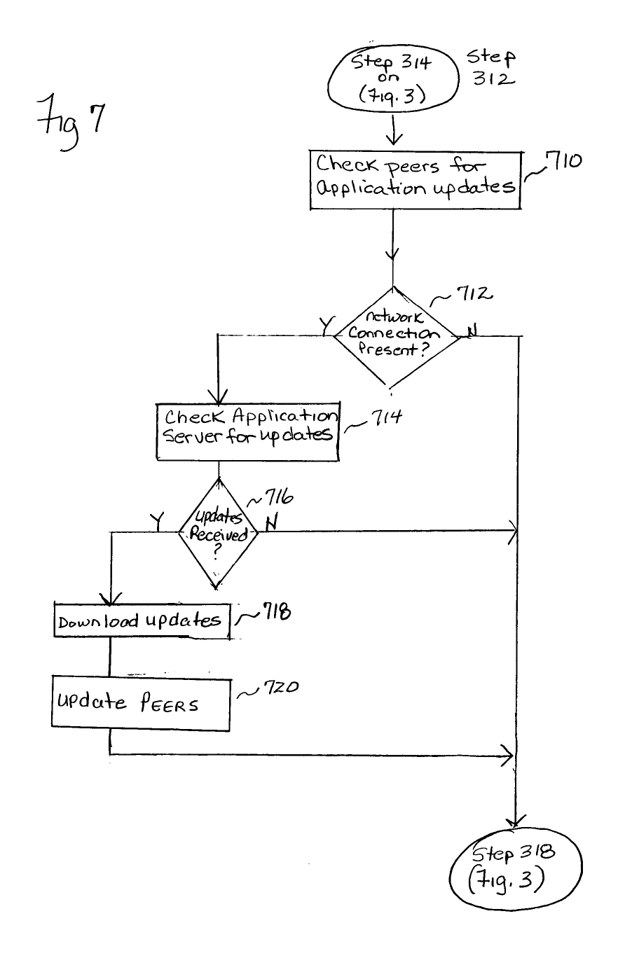

The resource manager 414 controls the availability of resources for use by the supervisor 412, the graphics engine 416, and the audio engine 418. Preferably, the resources are packaged into asset bags and scenes, wherein asset bags define an object and scenes define the interaction of the object. The asset bags and scenes are discussed in greater detail below with reference to FIGS. 5a and 5b, respectively, and the resource manager 414 is discussed in greater detail below with reference to FIG. 6.

The supervisor 412 generally controls the operation of the client application 400. The supervisor 412 determines the activities to be performed and the resources required to perform the activities. The supervisor 412 will be discussed in greater detail below with reference to FIG. 9.

FIGS. 5a and 5b illustrate an asset bag and a scene, respectively, in accordance with one embodiment of the present invention. As discussed above, the resources are packaged into asset bags and scenes. Asset bags are static data structures that define the presentation, e.g., appearance, sound, and the like, of an object, such as an animated character, a background object, a static character, and the like; and scenes define the view that is to be presented to the user.

As illustrated in FIG. 5a, the data structure of the asset bag includes a list of assets and a list of keys. The asset bag, however, may contain other information as required for a particular application or scenario. Preferably, assets of the list are identified by reference, i.e., the assets are identified by a pointer to a memory location. Storing of the individual assets in this manner allows assets to be widely reused while limiting the amount of memory allocated to each asset bag. The assets may include, for example, graphic shapes such as mouths, eyes, body shapes, and the like, sounds, backgrounds, bitmaps, data files, code files, and the like.

The asset keys define types or instances of assets and may include a list of assets, a structure between assets, a layout of the assets, timing information, and events. The list of assets is similar to the list of assets described above and allow asset bags to reference other asset bags.

The structure of an asset key defines the relationship between assets. For example, in a situation wherein the asset key is a list of bitmaps, the structure component of the asset key may define the position of one or more of the bitmaps. The position may be defined as an absolute position, e.g., the bitmap is to be located at x-pixel location 100 and y-pixel location 250, or as a relative position with respect to another bitmap, object, or asset, e.g., a first bitmap is to be located at a position 100 pixels to the right and 50 pixels down from a second bitmap.

The layout of the assets defines additional relationships between assets of the asset key and information or algorithms for presenting the assets to the user. For example, the layout of the assets may be used to apply a transformation algorithm to rotate a bitmap, relocate a bitmap, loop audio, and the like.

The timing of the assets defines the time period that the assets are to be presented to the user. For example, display a first asset for 100 milliseconds and play a first audio sound for 500 milliseconds. The timing may also be relative to actions taken with other assets, such as display a first asset for 10 seconds, but after 5 seconds play a first audio sound for 3 seconds.

Events of the assets define the interactions between the assets and actions taken by the user. For example, events specify what is to occur if the user clicks on the asset or on another asset. Additionally, events may be used to indicate non-user based events, such as timer events, audio finished playing events, and the like.

Referring now to FIG. 5b, scenes preferably contain a list of assets, shortcuts to specific assets, structure between assets, the layout of the assets, timing information, and events. Preferably, the list of assets, the structure between assets, the layout of the assets, the timing information, and the events behave similarly as described above with reference to the asset bags of FIG. 5a.

The shortcuts are preferably a reference to an asset bag or a reference to a specific asset key of an asset bag. For example, if a scene defines the presentation of a screen having one or more characters displayed on a background, the background information may be defined by an asset bag. A particular scenario, on the other hand, may require that a specific greeting be presented to the user. For example, an asset bag may be defined for a specific character. The asset bag may contain several introductory greetings, any one of which may be played. When defining a scene that presents the character, the designer may wish to have the character play a specific audio greeting. In these situations, the scene may include a shortcut that is a reference to a key name contained in the asset bag of the character. Accordingly, when the scene is performed, the character is displayed and the desired audio greeting is played.

FIG. 6 is a data flow diagram illustrating the steps that may be performed by the resource manager to retrieve assets requested by the supervisor 412 (FIG. 4). Processing begins in step 610 wherein a request is received for a specific scene or asset bag. Generally, the supervisor 412 may request either a specific asset bag or an entire scene. In either case, the asset bag and scene are evaluated to determine which assets the asset bag or scene require as illustrated in step 612. Because scenes and asset bags may contain references to other asset bags, it is preferable that each scene and asset bag be traversed such that all of the assets required to support the requested scene or asset bag are determined.

Furthermore, it is preferred that a version identifier be attached to each asset, asset bag, and scene. The use of a version number allows the resource manager 414 to determine if the most recent version is available and to ensure compatibility between assets, asset bags, and scenes.

In step 614, a list of assets or asset bags that are required by the requested scene or asset bag is generated, and in step 616, it is determined which assets and asset bags are not available on the present client. The assets and asset bags that are not located on the client are retrieved from other clients or the application server. The succeeding steps illustrate the preferred embodiment wherein the assets and asset bags are requested from peers prior to requesting the assets and asset bags from the application server. In this manner, it is expected that in a typical network the response time will be quicker because the assets will be retrieved locally on a machine that is not typically as busy as the application server 110 (FIG. 1). The system, however, could be designed to access the application server 110 directly.

In step 618, the client requests and receives a list of peers from which the client may request the missing asset bags and assets. Preferably, when a client application 105 is initiated on a client 114, the client application 105 broadcasts a message on the group network. The message may be, for example, a user datagram protocol (UDP) discover message. A client-server responds with an announce message, providing the identity of the client-server. The client-server is a client that, for the purposes of the application, is acting as a server. The client-server may or may not be the server for the network. The client-server maintains a list of clients running the client application and on which assets, asset bags, scenes, updates, and the like may be stored. Upon receipt of the announce message, the client transmits a message, preferably a TCP/IP message, to the client-server requesting to join the group of clients. The client-server responds by providing the client a list of current members, ie., clients, that are available. The client-server also preferably maintains a status list of the status of the clients on the group network. In this manner, the client-server knows if a particular client is busy downloading an update from the application server or is otherwise busy. In these situations, it is preferred that the client-server indicates that the busy clients are not available by not including the busy clients on the list of peers for the client to request missing asset bags and assets.

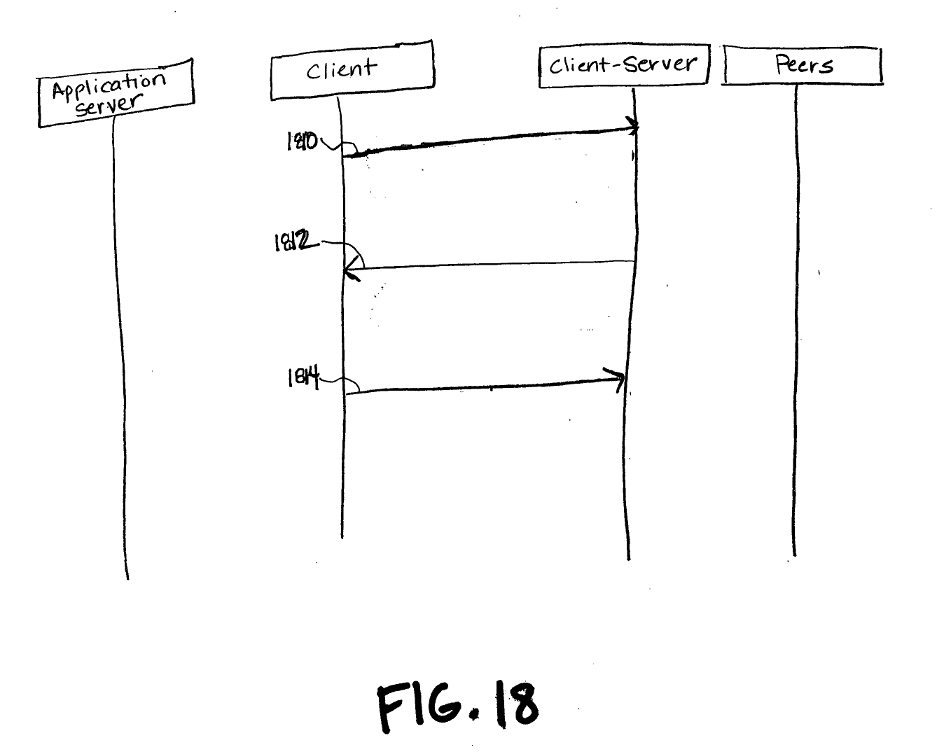

Optionally, the client-server may indicate that a response is or is not to be waited for from specific peers. In some situations, the client-server may not know exactly how busy a particular client is at a given time. In these situations, it may be preferred to request the missing asset bags and assets, but not to wait on a response and to continue requesting the information from other peers. An example of the messaging between the clients and the application server is discussed below with reference to FIGS. 18-20.

In step 620, a determination is made whether or not some or all of the required asset bags and assets are available on a peer client. If a determination is made that some of the requested information is available on a peer client, processing proceeds to step 622, wherein the requested information is retrieved from the peer client. If, however, a determination is made that some of the requested information is not available on a peer client, then processing proceeds to step 624, wherein the requested asset bags or assets are retrieved from the application server. It should be noted that the entire list of requested asset bags and assets do not have to be available from a single peer client. Information may be retrieved from a single peer client, a plurality of peer clients, the application server, or some combination thereof.

After performing steps 622 or step 624, processing proceeds to step 626, wherein the requested scenes, asset bags, and assets are made available to the supervisor and multi-media engine. Thereafter, the resource manager ceases until a new request is received when processing begins at step 610 as described above.

FIG. 7 is a data flow diagram illustrating the steps performed in accordance with one embodiment of the present invention to check for client application updates as discussed above with reference to step 316 of FIG. 3. Accordingly, after the client application is started from the client desktop in step 314, processing proceeds to step 316, the details of which are illustrated by steps 710-720 of FIG. 7.

The processing begins in step 710, wherein the client application checks other clients, i.e., peers, for application updates. Preferably the client application checks peers for updates in a manner similar to that described above with respect to step 618 performed by the resource manager.

Optionally, in step 712, a determination is made whether or not a network connection to the application server 110 (FIG. 1) is present. A network connection to the application server 110 may be absent for many reasons, such as the network connection to the client is down or disconnected, the network connection between the group network and the network is down or disconnected, the network connection between the application server 110 and the network is down or disconnected, the application server 110 may be down or disconnected, or the like. In any respect, it is preferred that the client accesses the application server 110 if possible to check for updates to the application.

Accordingly, if a determination is made in step 712 that a network connection is available to the application server 110, processing proceeds to step 714, wherein the application server 110 is checked for updates to the client application 105. In step 716, a determination is made whether or not updates to the client application have been received. If a determination is made that updates to the client application have been received, then processing proceeds to step 718, wherein the updates to the client application are downloaded to the client, and in step 720, the updates to the client application are sent to the other clients on the group network. Processing then returns to step 318 of FIG. 3.

Furthermore, if in step 712 a determination is made that a network connection to the application server 110 is not available or if in step 716 a determination is made that updates to the client application were not received then processing returns to step 318 of FIG. 3.

Optionally, the aspect of the present invention described herein may be utilized to update components present on the client, but not currently required by the client application. Generally, it is desirable that all of the application components, such as assets, asset bags, scenes, client applications, and the like, located on the client are consistent and compatible with each other. In this manner, a user is ensured that the components of the application located on the client are compatible in the event that the network connection to the application server is lost. Accordingly, it is desirable that the client determine if all of the components located on the client are of the latest version and consistent with each other. If a determination is made that all of the components are not consistent and compatible, then the inconsistent or incompatible components are updated, preferably from other clients or the application server.

FIG. 8 is a data flow diagram illustrating the steps performed in accordance with one embodiment of the present invention to check for knowledge base updates as discussed above with reference to step 320 of FIG. 3. Accordingly, after a user logs onto the client application 105 in step 318, processing proceeds to step 320, the details of which are illustrated by steps 810-822 of FIG. 8.

The processing begins in step 810, wherein the client application 105 retrieves the latest personal agenda for the specific user. As discussed above, the knowledge base 106 (FIG. 1) includes any information related to the personal use of the system by a specific user. For example, in one preferred embodiment in which the present invention is utilized for providing an educational system, the knowledge base 106 may include the activities that a student has participated in, the curriculum designed for that student or a group of students to which the specific student belongs, an activity graph (ie., a decision tree), the status of the student (e.g., what lessons the student has taken and the performance of the student in each lesson), and the like. If the specific user has used the current client machine in the past, the knowledge base 106 may be stored on the local client machine, and accordingly, this step retrieves the knowledge base 106 for the specific user from the local client machine.

Processing proceeds to step 812, wherein the client application 105 checks other clients, i.e., peers, for updates to the knowledge base 106. By checking for updates on other clients, a user is able to move from one client machine to another client machine and retain the current status of the user. Preferably the client application 105 requests updates from peers in a manner similar to that described above with respect to step 622 performed by the resource manager 414.

In step 814, a determination is made whether or not a network connection to the application server 110 (FIG. 1) is present. As discussed above, a network connection to the application server 110 may be absent for many reasons, such as the network connection to the client is down or disconnected, the network connection between the group network and the network is down or disconnected, the network connection between the application server 110 and the network is down or disconnected, the application server 110 may be down, or the like. In any respect, it is preferred that the client access the application server 110 if possible to check for updates to the application.

Accordingly, if a determination is made in step 814 that a network connection is available to the application server 110, processing proceeds to step 816, wherein the application server 110 is checked for updates to the knowledge base 106. In step 818, a determination is made whether or not updates to the knowledge base 106 have been received. If a determination is made that updates to the knowledge base 106 have been received, then processing proceeds to step 820, wherein the updates to the knowledge base 106 are downloaded to the client, and in step 822, the updates to the knowledge base 106 are sent to the other clients on the group network. Processing then returns to step 322 of FIG. 3.

Furthermore, if in step 814 a determination is made that a network connection to the application server 110 is not available or if in step 818 a determination is made that updates to the knowledge base 106 were not received then processing returns to step 322 of FIG. 3.

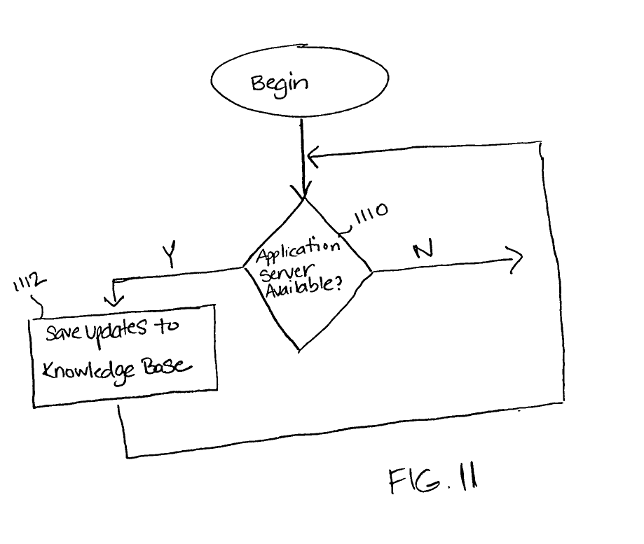

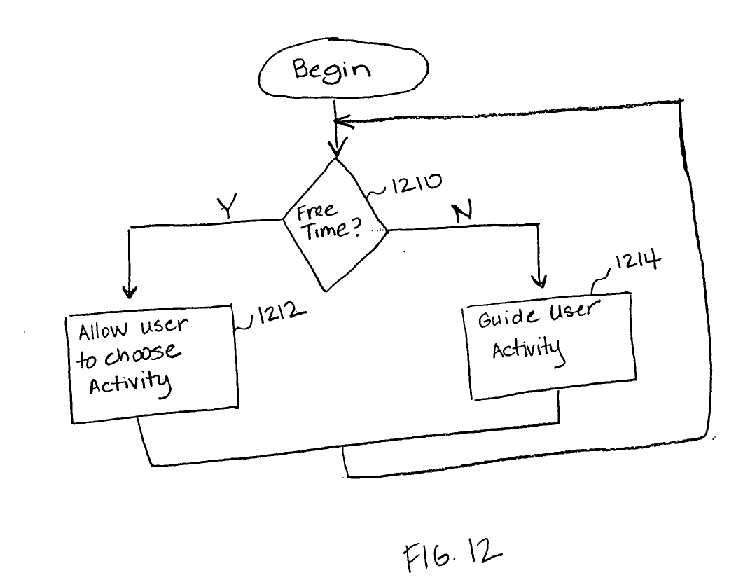

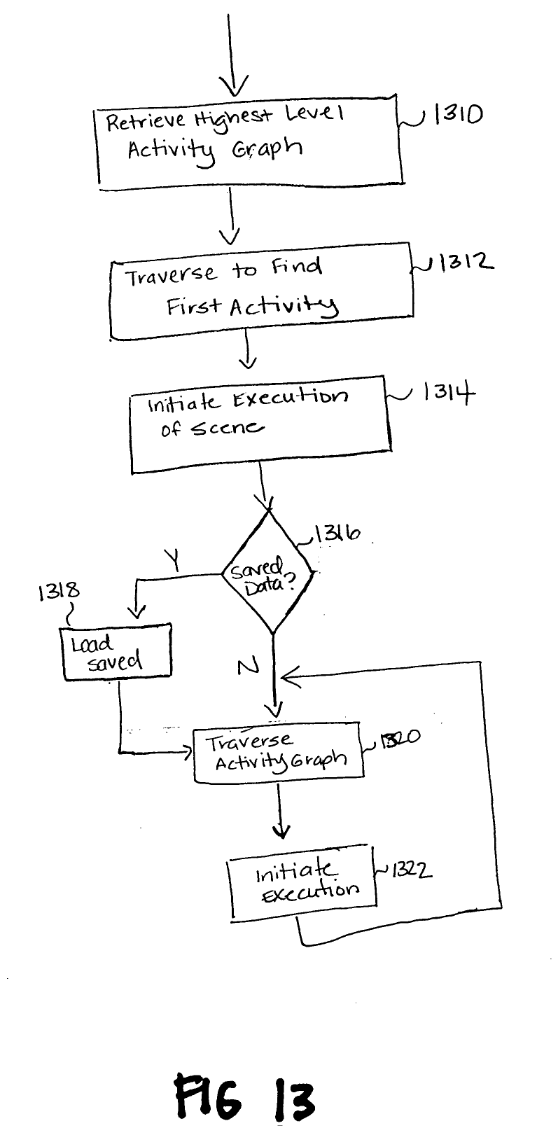

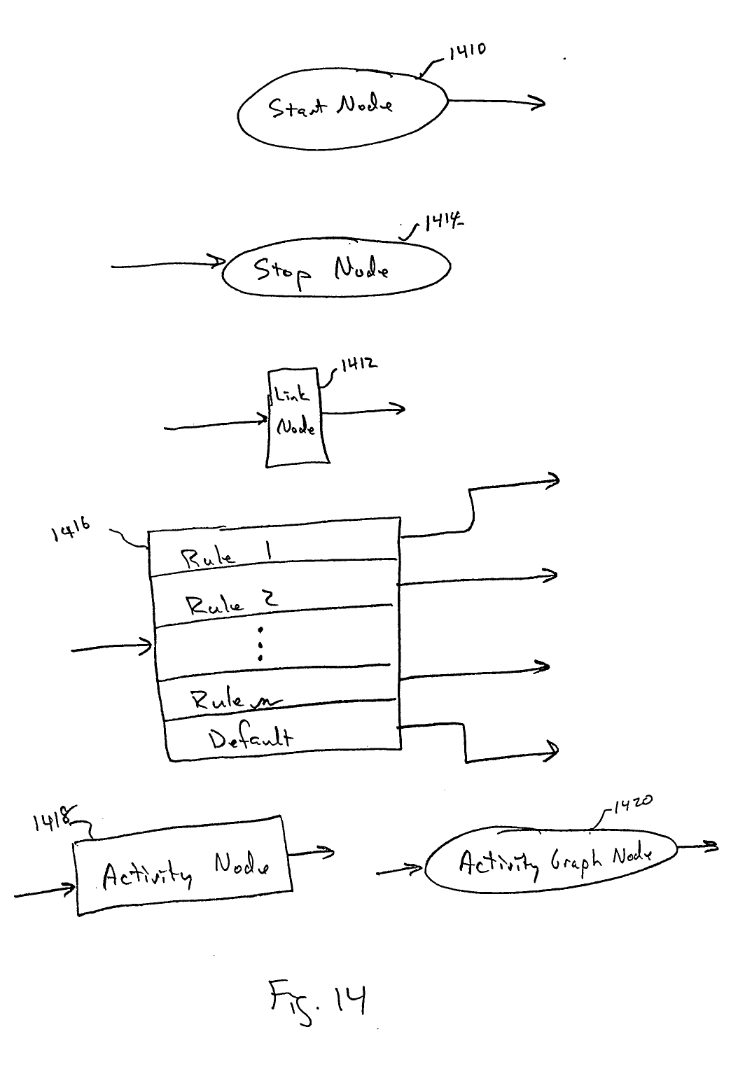

FIG. 9 is a data flow diagram illustrating the high-level view of the supervisor 412 (FIG. 4) in accordance with one embodiment of the present invention. Preferably, the supervisor 412 has one or more processes that run in parallel. In the preferred embodiment, the supervisor 412 has a predictive fetching process 910, a store results process 912, a free time process 914, and an application process 916. The predictive fetching process 910 is described below with reference to FIG. 10; the store results process 912 is described below with reference to FIG. 11; the free time process 914 is described below with reference to FIG. 12; and the application process 916 is described below with reference to FIG. 13.

FIG. 10 is a data flow diagram illustrating the steps performed for predictive fetching in accordance with one embodiment of the present invention. In particular, FIG. 10 describes the steps performed for predictive fetching as discussed above with reference to step 910 of FIG. 9. Predictive fetching may retrieve knowledge base information, multi-media assets, other assets, client applications, and the like.

The processing begins in step 1010, wherein the current user activity is determined. The current user activity may be viewing a particular document, working on a particular lesson plan, or the like. Processing then proceeds to step 1012, wherein the possible future activities are determined. Preferably, a decision tree or activity graph is maintained that defines the possible paths that a user may traverse depending upon the current state of the user and the possible actions of the user. As will be described below with reference to FIGS. 14-17, activity graphs are similar to a hierarchical graph or a decision tree that identifies the activities and branches that a user may take. The possible future activities are determined by traversing the activity graph beginning at the current location of the user.

In step 1014, a determination is made whether or not the assets, asset bags, and scenes for the future activity are available on the client. In the preferred embodiment, the versioning information is contained in the activity graph. Accordingly, this step checks the client resources to determine if the asset is located on the client and whether or not the asset is of the correct version.

If a determination is made that the asset is not available on the client, then processing proceeds to step 1016, wherein a determination is made whether or not the required asset is available on other clients. Preferably the client application checks peers for updates in a manner similar to that described above with respect to step 618 performed by the resource manager.

If a determination is made that the requested asset is not available on the other clients, then processing proceeds to step 1020, wherein a determination is made whether or not a network connection to the application server 110 (FIG. 1) is present. If a determination is made in step 1020 that a network connection is available to the application server 110, processing proceeds to step 1022, wherein the requested asset is downloaded from the application server 110. In step 1024, the client optionally sends the updates to the other clients.

If, in step 1016, a determination is made that the requested asset is available from the other clients or peers, then processing proceeds to step 1018, wherein the requested asset is retrieved from the peer having the requested asset.

If a determination is made in step 1020 that a network connection to the application server is not available or after performing steps 1018 or 1024, processing proceeds to step 1026, wherein a determination is made whether or not to check for additional assets for future use. Preferably, the amount of assets for future use by the user is dependent upon the amount of disk storage available on the client, the size of the assets, the bandwidth available to retrieve assets, the amount of assets readily available on the client, the expected duration before an asset is expected to be required, and the like. Alternatively, the client may download as much of the application as possible. For smaller applications or applications in which the user may jump around quickly, this may be an acceptable approach.

If, in step 1026, a determination is made that other assets should be retrieved, then processing returns to step 1010, wherein the predictive fetching process is repeated. If, however, a determination is made that other assets should not be retrieved at the moment, processing proceeds to step 1028, wherein the predictive fetching process is suspended. The predictive fetching process may be suspended for a period of time, until a predetermined event occurs, an activity has been completed, memory has been freed, or the like. After the suspension period ends, processing returns to step 1010, wherein the predictive fetching process is repeated.

FIG. 11 is a data flow diagram illustrating the steps performed for storing updates to the knowledge base 106 in accordance with one embodiment of the present invention. In particular, FIG. 11 describes the steps performed for updating the knowledge base 106 as discussed above with reference to step 912 of FIG. 9. Generally, as a user utilizes the application process 916, the knowledge base 106 entries relating to that user are updated. It is preferred that a local copy of the knowledge base 106 is maintained on the client machine and that the knowledge base 106 on the application server 110 is updated periodically. The knowledge base 106 on the application server 110 may be updated at predetermined intervals, upon the occurrence of a specific event, in the background as time permits, or the like. In the preferred embodiment, the knowledge base 106 is periodically updated in the background so as not to affect the performance of the client application 105. In this manner, the speed of the application is not affected by the periodically saving the knowledge base 106 to the application server 110.

Accordingly, processing begins in step 1110, wherein a determination is made whether or not the application server 110 is on-line, i.e., available. If a determination is made that the application server 110 is available, then processing proceeds to step 1112, wherein the knowledge base 106 contained on the application server 110 is updated with the information contained on the client.

If the application server 110 is not available in step 1110 or after the updates to the knowledge base 106 have been saved on the application server 110, processing returns to await the next update cycle, such as a time interval, an event, or the like.

One skilled in the art will appreciate that this type of configuration allows for the application system to automatically heal itself. For example, if the application server 110 goes down for an extended period of time, a user may continue utilizing the client. Progress or activities performed by the user on the client will be maintained locally on the client. When the network connection to the application server 110 is reinstated, the system automatically and seamlessly updates the knowledge base 106 on the client and the application server 110, bringing the clients 114 and the application server 110 into synch.

FIG. 12 is a data flow diagram illustrating the steps performed for determining whether the supervisor or the user determines the activity that the user is to perform in accordance with one embodiment of the present invention. In particular, FIG. 12 describes the steps performed for determining free time as discussed above with reference to step 914 of FIG. 9. Generally, the supervisor may want to guide the user in the activities that the user performs. In some instances, however, the supervisor may allow the user to choose the application. For example, in a preferred embodiment of the present invention in which the present invention is utilized to implement an educational system, the supervisor may guide the activities of the student until the student has reached a predetermined point, such as a lesson, spent a predetermined amount of time utilizing the application system, achieved a predetermined score, or the like, when the application system allows the user to choose the activity. The activity may be a game, chat, surfing the Internet, or the like.

Processing begins in step 1210, wherein a determination is made whether or not the user has earned free time. Free time may be earned by any indicator appropriate for the specific application, such as those listed above with respect to an educational system. If a determination is made that the user has earned free time, then processing proceeds to step 1212, wherein the user is allowed to select the next activity. If, however, a determination is made that the user has not earned free time, then processing proceeds to step 1214, wherein the supervisor determines the next activity.

Thereafter, processing returns to the beginning to step 1210. Preferably, this process is repeated periodically or as the user completes specific activities, thereby periodically determining whether or not the user has earned free time.

FIG. 13 is a data flow diagram illustrating the steps performed to provide an application in accordance with one embodiment of the present invention as discussed above with reference to step 916 of FIG. 9. It should be noted, however, that the following description of an application is provided for illustrative purposes only. The framework described herein, including but not limited to peer-to-peer application networking, application data management techniques, predictive data management techniques, and the like, is applicable to many types of applications. For example, embodiments of the present invention may be used for software sales and distribution, on-line tutorials, documentation systems, and the like.

In particular, FIG. 13 is a data flow diagram illustrating the steps that the supervisor 412 (FIG. 4) may perform to traverse an activity graph in accordance with one embodiment of the present invention. Processing begins in step 1310, wherein the supervisor 412 retrieves the highest level activity graph. In step 1312, the supervisor 412 traverses the activity graph until the first activity is encountered. The first activity encountered may, for example, represent a welcome screen or initiation scene. The nodes encountered prior to the first activity node may initialize variables, setup shortcuts to assets, initialize aliases, or the like.

In step 1314, the supervisor initiates execution of the scene associated with the activity. In the preferred embodiment discussed above, wherein object oriented design techniques are utilized, the scene is executed by instantiating an object for the scene that is to be performed. In this manner, methods on the object may be provided to retrieve shortcuts, load assets, initialize variables, initialize aliases, perform the scene, and the like.

Preferably, the execution of the scene is controlled by the multimedia engine. As discussed above, the multimedia engine preferably comprises an interpretative language interpreter and an executable. The executable controls the logic and retrieval of information, and the interpreter handles the majority of user interaction, such as formatting the display, playing of the sounds, and the like. The interpretive language script also controls the response to user and system events, such as mouse clicks, timer events, and the like.

After the scene has been executed by the multimedia engine, processing returns to the supervisor wherein step 1316 is performed. In step 1316, a determination is made whether or not saved data associated with the user exists. As discussed above, the system is preferably capable of indicating when to save information and status such that the user is able to return to that specific location at a later time. Accordingly, if a determination is made that saved data exists for the user, then processing proceeds to step 1318, wherein the saved information is retrieved.

Thereafter, or if a determination is made that the user is not a return user, processing proceeds to step 1320, wherein the supervisor 412 continues to traverse the activity graph to determine the next scene that is to be executed. In step 1322, the scene is executed as discussed above. Thereafter, processing returns to traverse the activity graph to locate the next scene to execute.

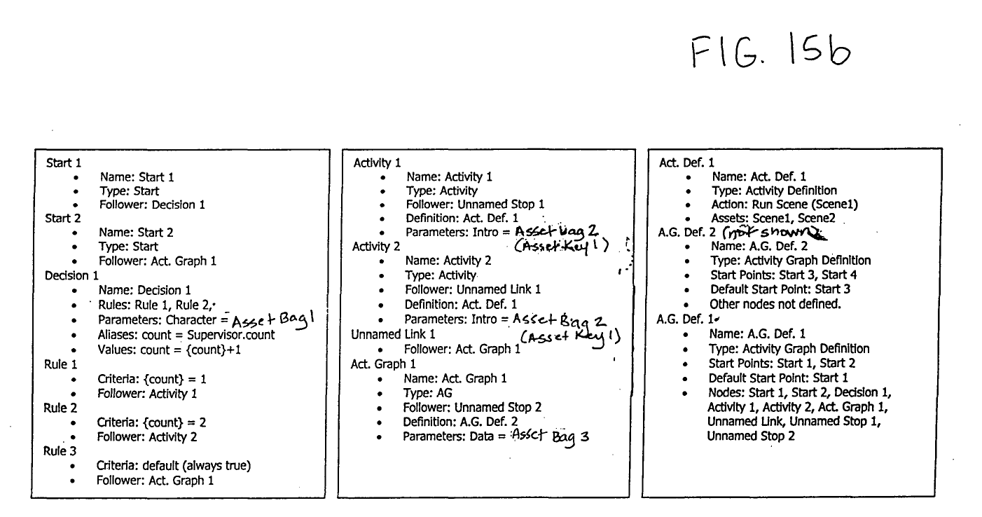

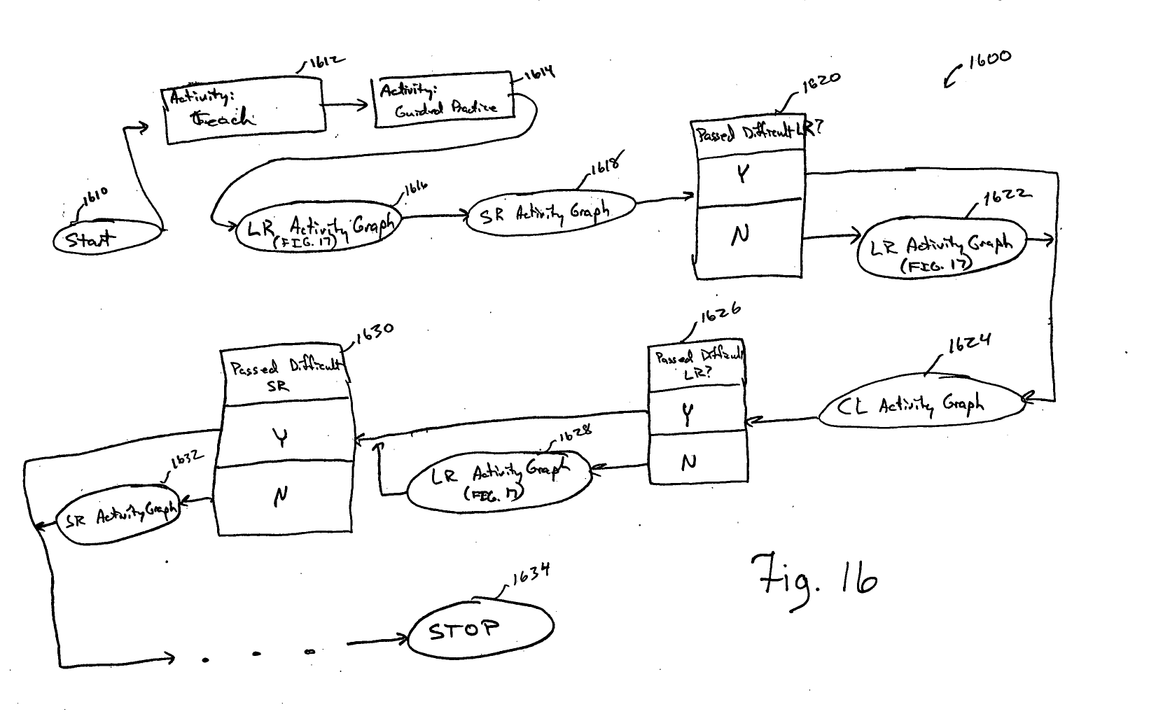

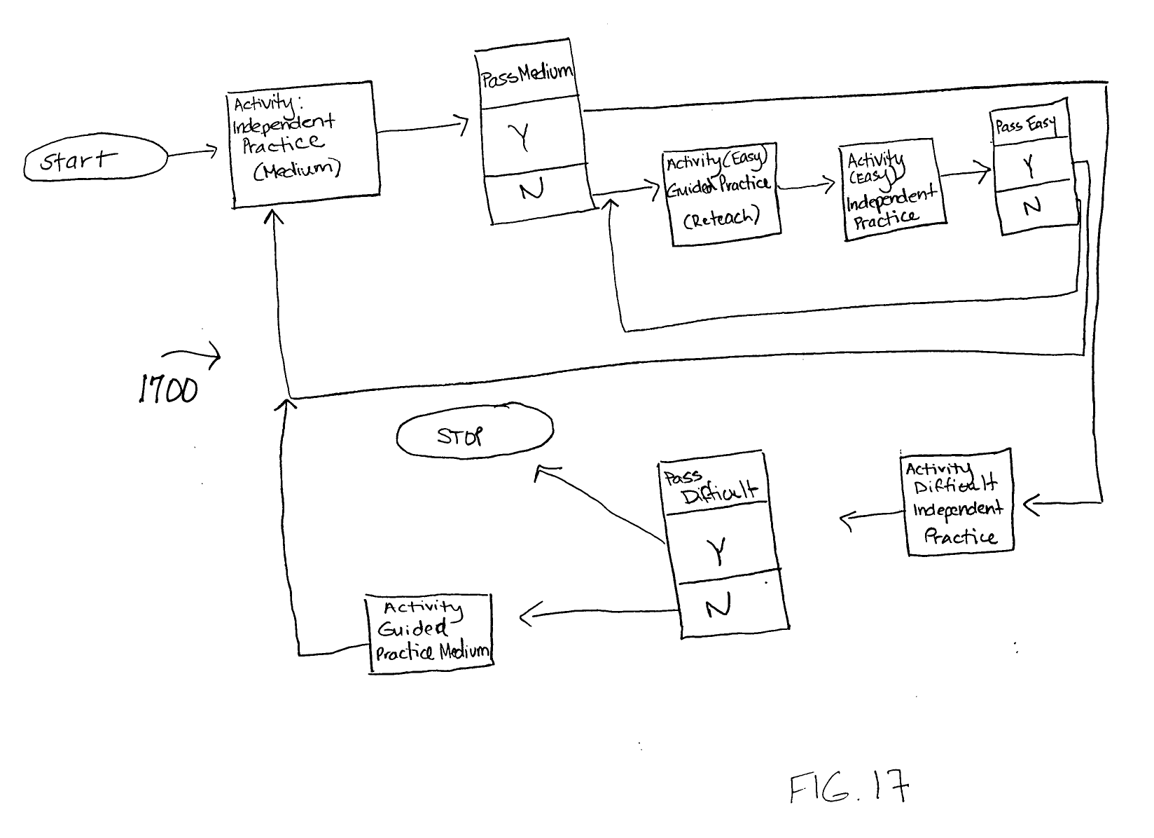

FIGS. 14-17 illustrate a method of forming an activity graph in accordance with one embodiment of the present invention and an example thereof. Specifically, FIG. 14 illustrates the types of nodes that may be used to encapsulate an activity graph; FIG. 15 illustrates the nodes discussed in FIG. 14 combined to form a generic activity graph; and FIGS. 16-17 illustrate an example of an activity graph that may be utilized in an educational application system. Generally, an activity graph defines the scope and sequence of the client application. In the preferred embodiment, the activity graph comprises nodes and relationships. The nodes represent an action that is to be performed by the client application, such as an activity, a decision, start, stop, and the like. It is also preferred that the activity graphs may refer to other activity graphs. The relationship between nodes represents the sequence that the nodes are to be evaluated. The client application traverses the activity graph and performs the actions identified by the nodes in the sequence specified by the relationships. The nodes refer to scenes, assets, and asset bags.

As one skilled in the art will appreciate, the client application is relatively small and interprets and performs the action defined by the activity graph. The activity graph can be downloaded in smaller portions as the user requires them. Furthermore, the activity graph as well as the assets, asset bags, and scenes can be easily modified to create different applications and user interfaces. The activity graph contains pointers to the data and scripts, such as assets, asset bags, scenes, code scripts, versioning information, and the like, that the client application 105 requires to properly execute the activity graph.

FIG. 14 identifies nodes that may be used to form an activity graph in accordance with one embodiment of the present invention. The nodes identified herein are provided for illustrative purposes only, and as one of ordinary skill in the art will appreciate, an activity graph may be defined using more or less types of nodes. The nodes may be represented in any suitable format, such as relational database objects, class objects stored in memory in object-oriented design, a flat file, or the like. Preferably, however, the nodes are represented as in various methods for varying purposes. For the purpose of storing the nodes on the application server, the nodes are preferably represented as relational database objects, wherein they may be associated with other information for reporting purposes and the like. For transmittal across the network and storage on the client, the nodes are preferably converted to in-memory object-oriented class data structures, and converted to compressed binary representations of the data structures. The data structures may then be transmitted and stored, along with version info, CRC32 validity info, and the like. On the client, the compressed binary representation is converted back to in-memory object-oriented data structures. For the purpose of storing nodes in the relational database, text files using .ini file format may be created and converted to object-oriented (OO) in-memory data structures, converted to compressed binary, and published to the server. The nodes may also be stored in the relational database by creating text files using XML format, converting and publishing the text files to the relational database, or a tool which creates and operates directly on the OO in-memory data structures may be used.

Start node 1410 identifies an entry point into an activity graph. Each activity graph has one or more start nodes followed by one or more other types of nodes. Preferably, the start node contains three fields: a name or identifier field, a type field identifying itself as a start node, and a link field. The link field includes a link or reference to the node that is to be executed or performed immediately after the start node. The link field may contain a single link in the case of serial processing or may contain a plurality of links in the case of parallel processing.

A plurality of links may also be used if some activities are identified as being performed in the foreground or background. Generally, activity graphs determine the user interaction, but activity graphs may also be used to gain greater control over the programming or behavior of the underlying client application 105. For example, a node may be designed to instruct the client application to download information from the application server, send a message, post a message, or the like. The client application 105 may be modified to interpret and process many varying types of nodes to perform any function.

A stop node 1414 identifies an end point. When a stop node 1414 is encountered, processing returns to the activity graph that instantiated the current activity graph.

A link node 1412 provides a method for a designer to specify data or actions that are to be performed prior to performing the succeeding steps. For example, link nodes allow a designer to perform knowledge base updates, choose asset bags when an activity completes, or the like.

A decision node 1416 provides a method of instructing the client application to branch to various nodes of the activity graph based on specified criteria. Each decision node 1416 preferably includes a name or an identifier, one or more value identifiers or decisions, one or more aliases that map the identifiers or decisions to locations in the knowledge base 106, and one or more rules. Preferably, the identifiers or decisions specify a condition that is to be evaluated by the client application. Depending upon the value of the decision or identifier, the corresponding rule defines the path that is to be followed. Furthermore, it is preferred that the decision node 1416 allow the knowledge base 106 to be updated with the value calculated.

For example, a decision node 1416 may be used to branch according to the value of a counter that indicates the number of times a user has performed a certain activity. For each time a user performs an activity, a branch may be performed that alters the logic, the sequence, the assets, the scenes, the asset bags, or the like. The knowledge base 106 is updated with the new value of the counter.

Activity node 1418 is a definition of an action that is to be performed and the parameters for that action. The activity node 1418 preferably contains a name or identifier, a type field identifying the node as an activity node, a follower field indicating the node that is to be traversed after completion of the current activity node, a reference to a definition, and a reference to one or more parameters. The definition of the activity defines the specific activity that is to be performed. Preferably, the activity comprises a scene that is to be performed and the assets or asset bags that are to be utilized by the scene.

For example, in a preferred embodiment of the present invention wherein a software application with user interaction is designed, an activity node may contain a reference to a definition that defines a specific character on a specific background. A parameter of the activity node may indicate that a specific greeting related to the specific character is to be played. In another branch, the same activity may be specified, but a different greeting message may be specified by the parameters of the activity node.

An activity graph node 1420 identifies another activity graph that is to be traversed before proceeding onto the next node. In this manner, it is possible to design a series of activity graphs, each with its own activity scope and sequence, and easily link between the activity graphs. Each activity graph node 1420 preferably comprises a name or identifier, a type field identifying the node as an activity graph node, a follower node that identifies the node that is to be traversed after returning from the activity graph, a reference to the activity graph definition, and one or more parameters. The definition of the activity graph includes an identification of the nodes, start nodes, and a default start node. Parameters passed into an activity graph may include an asset or an asset bag. Thus, an activity graph may be traversed one time with an asset bag having a first set of characters and traversed another time with an asset bag having a second set of characters.

Additionally, each type of node may optionally contain information or directions to store or update values to the knowledge base 106, to calculate values, to identify asset bag information or shortcut mappings, or the like. These fields are particularly useful in stop 1414, start 1410, and link 1412 nodes wherein an asset, an asset bag, a scene, or the like may be identified for use in a succeeding step or status information stored. Furthermore, each type of node may also specify one or more optional parameters. Parameters are particularly useful to specify a mapping between a shortcut in a scene and the asset bag used to satisfy that need. For example, if a node includes a parameter “Character=Asset Bag 1,” then succeeding nodes that. referred to “Character” will use “Asset Bag 1” as a definition for that character. In this manner, the look and feel of a scene may be changed easily and dynamically.

Preferably, the nodes include a save field. In many instances, a user will not complete the entire curriculum or activity graph in a single session. Therefore, it is desirable to indicate locations or nodes to which the user may return to directly in a later session. The same field may be a Boolean field, wherein “True” may indicate that a user may return directly to that node and “False” may indicate that a user may not return directly to that node. Upon encountering a node having a save field set to “True,” the system preferably saves all status information necessary for the user to return uninterrupted to that node in a later session.

FIGS. 15a and 15b are an activity graph and the corresponding definition of the fields of each node, respectively, that may be created in accordance with one embodiment of the present invention. Activity graph 1500 has two start nodes 1510 and 1512. The different start nodes allow the activity graph 1500 to be entered under different conditions, thereby allowing further customization of the activity graph 1500. Start node 1510 is linked to a decision node 1514, which identifies an alias and a value. The decision node 1514 defines three rules or branches: a first branch that is to be taken when the value of the alias is equal to 1, a second branch that is to be taken when the value of the alias is equal to 2, and a third branch that is to be taken in all other cases, i.e., a default branch. Furthermore, the decision node 1514 defines a parameter as “Asset Bag 1.”

If the result of the decision node 1514 is either 1 or 2, a branch is made to activity nodes 1516 and 1518, respectively. As illustrated by the contents of the activity node, both activity nodes 1516 and 1518 refer to an activity definition 1 (“Act. Def. 1”), wherein activity node 1516 contains a parameter of asset bag number 2 with an asset key number 1 (“Asset Bag 2 (Asset Key 1)”) and activity node 1518 contains a parameter of asset bag number 2 with an asset key number 2 (“Asset Bag 2 (Asset Key 2)”). Thus, both activity nodes 1516 and 1518 would perform the same function, but play a different introductory prompt.

After activity node 1516 is completed, the activity graph 1500 is completed as indicated by the stop node 1520. After activity node 1518 is completed, however, the activity graph node 1522 is entered. Note that activity graph node 1522 is also entered when the activity graph 1500 is entered at start node 1512 or when the decision node 1514 takes the default branch.

The activity graph node 1522 refers to an activity graph definition “A.G. Def. 2,” which defines the entry points and nodes, with a parameter of asset bag number 3.

FIGS. 16 and 17 are illustrative examples of activity graphs that may be created in an educational application in accordance with one embodiment of the present invention. In particular, the activity graphs illustrated in FIGS. 16 and 17 may be used as a portion of a system utilized to teach elementary school students how to read.

The activity graph 1600 (FIG. 16) begins in the start node 1610. It is assumed that the activity graph 1600 was instantiated by another activity graph or is an upper level activity graph. For example, the activity graph 1600 could have been instantiated with an asset bag as a parameter that causes the activity graph 1600 to teach a specific letter of the alphabet.

The first node encountered is an activity node 1612, which may perform a scene that performs a teaching process to teach a student a particular letter. After completing the activity node 1612, the activity graph 1600 is traversed to get the next node, i.e., activity node 1614. In this case, the activity node 1614 may perform a scene that performs a guided practice session that guides the student through a series of practice sessions.

The next node that is evaluated is activity graph node 1616, which is illustrated in further detail below with reference to FIG. 17 for illustrative purposes only. In this example, the activity graph node 1616 causes an activity graph regarding a letter recognition (LR) lesson to be traversed. Upon completing the LR activity graph node 1616, an activity graph regarding a sound recognition (SR) lesson is traversed. The activity graph referenced by the LR activity graph node 1616 and the SR activity graph node 1618 may be the same or different.

A decision node 1620 determines whether or not the student has successfully passed the LR lesson at a difficult level. If the student has not, the “N” branch of decision node 1620 is taken, wherein the LR activity graph is traversed again. Note that preferably activity graph node 1616 and the activity graph node 1622 reference the same activity graph, which is illustrated in FIG. 17. The activity graph nodes 1616 and 1622, however, may pass the activity graph different parameters, thereby customizing the activity graph to a particular situation. For example, the scenes and characters may be changed, the audio prompt may differ, the sequence of events may differ, or the like.

Nodes 1624-1632 further illustrate the customization and efficiency that is allowed by the use of activity graphs and reusable components, e.g., activity graphs, nodes, scenes, assets and asset bags. Note also that the LR activity graph is instantiated again in step 1628, allowing the same activity graph to be utilized in a different situation and with different parameters.

FIG. 17 illustrates an activity graph that may be referred to by another activity graph, such as activity graph nodes 1616, 1622, and 1628 of FIG. 16, in accordance with one embodiment of the present invention. Activity graph 1700 utilizes the same techniques discussed above with reference to FIG. 16 and illustrates that an activity graph may be reused. Preferably, an activity graph, such as activity graph 1700, accepts parameters in the form of scenes, assets, asset bags, and the like, to customize each instance. In this manner, each performance of the activity graph is easily customized to a specific situation, altering the look and feel and user interaction of the application.

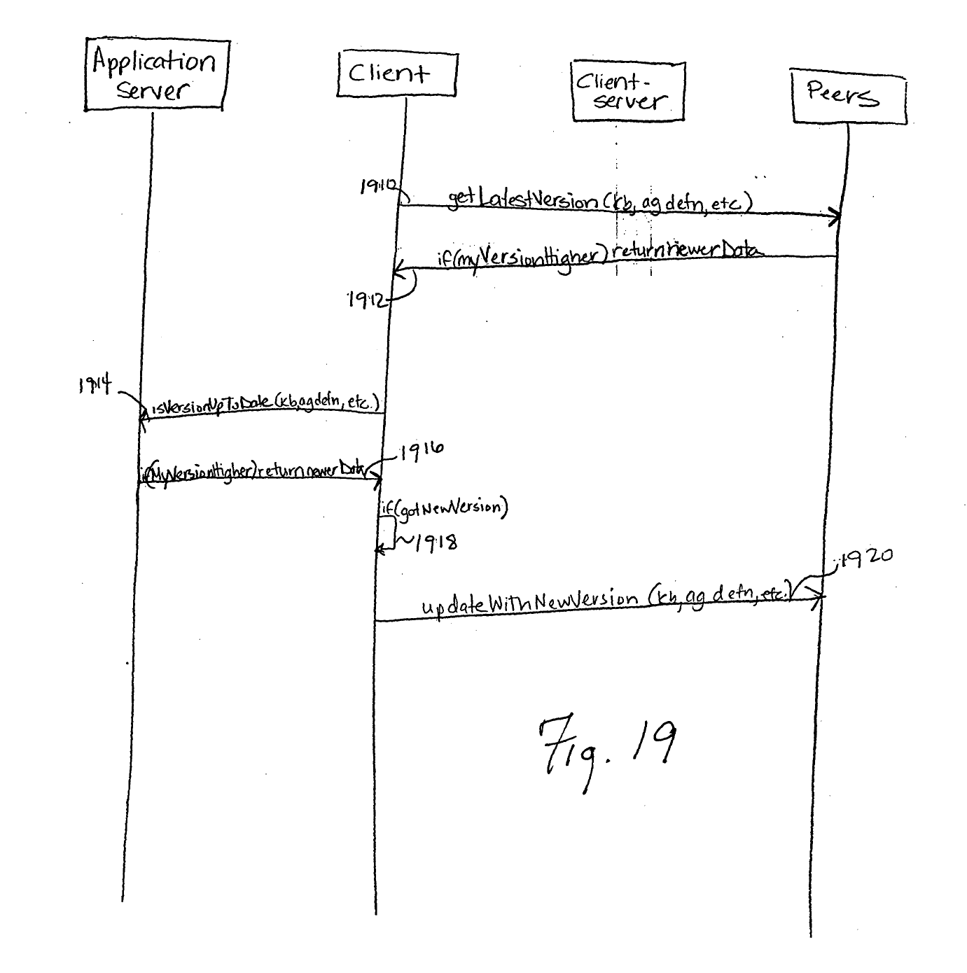

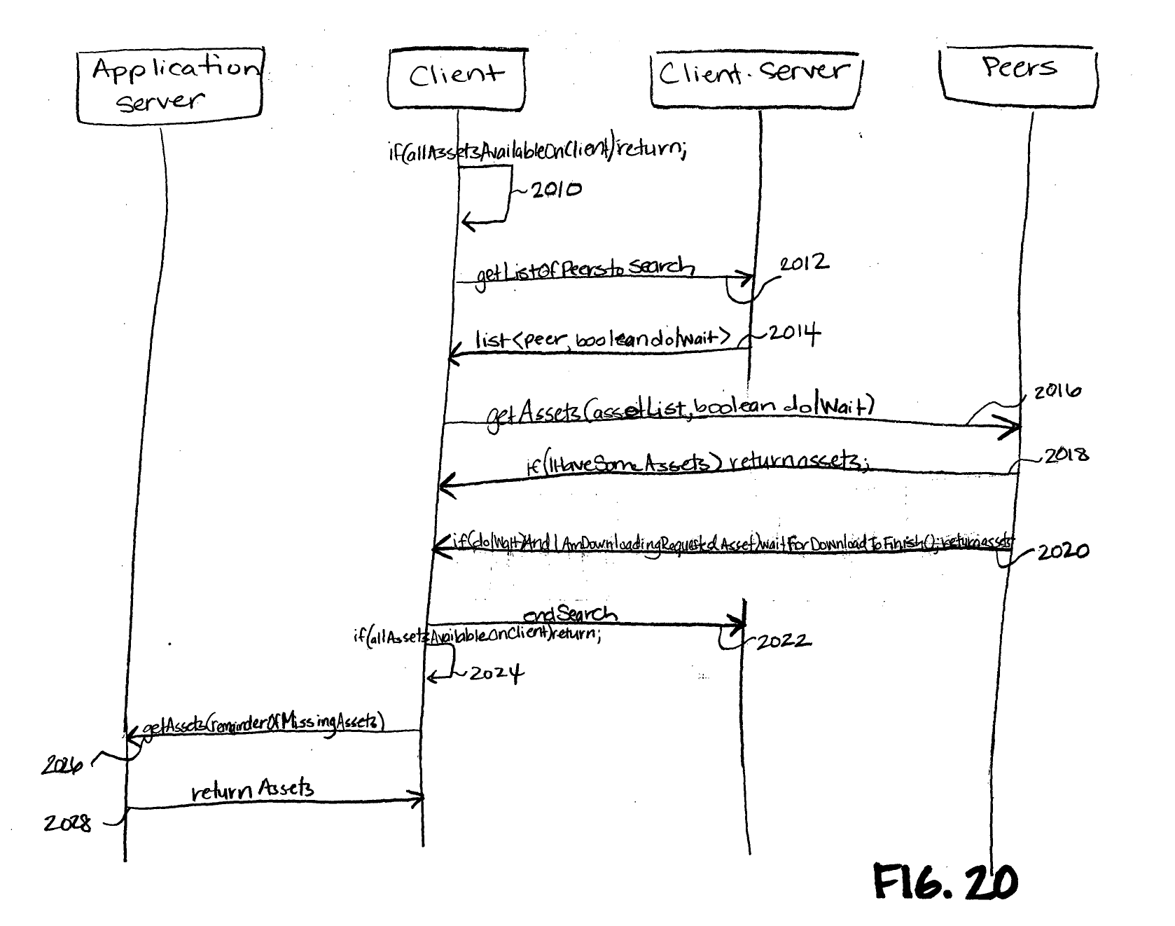

FIGS. 18-20 are messaging diagrams that may be utilized by the client to communicate with other clients and the application server 110 (FIG. 1) in accordance with one embodiment of the present invention. In particular, FIG. 18 illustrates a message flow that may be used by the client at startup to join a group of clients; FIG. 19 illustrates a message flow that may be used by the client to synchronize the knowledge base and activity graph definition; and FIG. 20 illustrates a message flow that may be used by the client to retrieve assets.

Referring now to FIG. 18, message 1810 is a discover message that is broadcast across the group network by the client upon initiation. When a client first begins to execute, it is desirable that the client determine if other clients, i.e., peers, are running on the group network, from which it may be possible to retrieve assets at a later time. Accordingly, the client preferably broadcasts a message 1812, such as a discover UDP message, on the group network. In response, the client-server responds with a message, such as an announce UDP message, indicating that other clients are available on the group network and the identity of the other active clients or peers (other clients that are available to share resources). As discussed above, the client-server is the client that is the first client to begin execution and will coordinate the interaction between clients. The identification of a client-server is not necessary, but provides an efficient manner to prevent lock-ups and overloading specific clients.

After the client receives the announce message 1812, the client responds with a message 1814, such as a Join you TCP/IP message, to request that the client-server add the client to the group of active clients. Thereafter, the client will participate in sharing files with the other active clients on the group network.

Referring now to FIG. 19, a message flow that may be used to synchronize the activity graph and knowledge base is illustrated. The messages illustrated on FIG. 19 may be, for example, TCP/IP messages. Message 1910 represents a series of messages sent to the peers to request later (more recent) versions of the knowledge base, activity graph definitions, a portion thereof, or the like. Preferably, message 1910 is sent to each active client utilizing a round-robin technique or some other load-distribution scheme. Alternatively, the message may be transmitted to each client or specific client pairs may be arranged.

If a peer has a later version of the requested information, then the peer responds with a message 1912, wherein the peer returns data corresponding to a later version of the requested information. After receiving responses from the peers, the client transmits to the application server a message 1914 to inquire to the application server 110 whether the client has the latest version of the requested information. The application server 110 responds with message 1916 wherein if a later version of the information is available, the application server 110 returns the later version of the data.

Messages 1918 and 1920 indicate that if the client received a later version of the information from the application server (message 1918) the client transmits the new data to the peers (message 1920). Preferably, the new data is transmitted to the peers in a round-robin manner.

Referring now to FIG. 20, a message flow that may be used to retrieve assets is illustrated. The messages illustrated on FIG. 20 may be, for example, TCP/IP messages. Message 2010 represents a check by the client to determine if the client has the requested assets available on the client. If the assets are available on the client, then the remaining messages illustrated on FIG. 20 may be skipped.

If the assets are not available on the client, then the client preferably retrieves a list of active clients from the client-server. This may be performed by messages 2012 and 2014. Message 2012 is transmitted by the client to the client-server to request a list of active peers. The client-server responds by transmitting message 2014 to the client with a list of peers. Preferably, the list of peers includes an indication of whether or not the client should wait for a response from each specific peer. As discussed above, the client-server preferably maintains a status of the peers, and if the peer is busy performing other tasks then the client-server may indicate that the client should not wait for a response from the busy peer to prevent long, unnecessary delays.

After the client receives a list of peers, the client transmits a message 2016 to each peer, preferably in a round-robin manner or other scheduling technique, to request from the peer a list of assets that are required by the client. The peer responds by transmitting to the client all of the assets that are included in the list and that are available to the peer. Alternatively, if the peer is currently downloading the requested assets, then the peer may respond with a message 2020. Preferably, if a client receives message 2020, the client waits for the peer to download the asset and receives the asset from the peer, thereby reducing the load on the network and the application server 110.

After the client receives a response from the peers or has received the requested assets, the client may transmit to the client-server a message 2022 to inform the client-server that the client has completed the search for assets on the peers. Message 2024 indicates that the client determines whether or not the client has retrieved all of the assets required. If the client was unable to retrieve all of the required assets from peers, then the client may request the assets from the application server 110, as indicated by messages 2026 and 2028. Message 2026 requests the missing assets from the application server 110, and message 2028 represents the application server 110 returning the missing assets. Thereafter, the required assets are available on the client and the client can continue execution.

In an alternative embodiment, features of the present invention described herein may be utilized to distribute software applications and the like. For example, a vendor may allow a first person or representative of a corporation to download via the Internet, or some other electronic connection, a software application from a vendor server to a first client. Other employees or representatives of the corporation may then access the software application from either the vender server or the first client. As other clients download the software application, those clients may then be accessed by other clients, thereby increasing the number of potential download sites with each download. This technique may be particularly useful in situations in which a corporation purchases a number of licenses or a site license wherein the software application may be downloaded once and distributed quickly and efficiently from client-to-client. Such a networking scheme significantly reduces the demands of the vendor server and allows the software application to be quickly distributed and less demand on any one server. Preferably, the download process is handled seamlessly in that the client automatically determines the availability of the software application from other clients and the vendor server and retrieves the software application from the most suitable location.

In another alternative embodiment, the above process could be utilized in a “push” distribution as opposed to a “pull” distribution scheme. In this “push” distribution scheme, the client receives the software application, or some other data, and automatically distributes the software application to other clients. One particular scenario in which this technique may be useful is providing updates to an existing software application. A first client may download an update and automatically distribute the update to other clients. After a client downloads the update, that client can in turn update other clients, thereby increasing the download sites and quickly distributing the update.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

1. A method of providing information on a client, the method comprising:
receiving on the client a client application, the client application requiring a plurality of resources to execute;
determining by the client a subset of the resources that the client application requires;
retrieving the subset of the resources; and
performing the client application with the subset of resources to provide information.

2. The method of claim 1 wherein the resources include assets, asset bags, scenes, audio files, or graphics files.

3. The method of claim 1 wherein the client application is an interactive application.

4. The method of claim 1 wherein retrieving includes retrieving the subset of assets from a peer client.

5. The method of claim 1 wherein retrieving includes retrieving the subset of assets from an application server.

6. The method of claim 1 wherein retrieving includes the steps of:
requesting the subset of resources from one or more peer clients;
determining a second subset of resources as the subset of resources that were not received from the one or more peer clients; and
requesting the second subset of resources from the application server.

7. A method of providing an interactive application on a client, the method comprising:
receiving from an application server a client application and a scene, the scene defining the interaction between one or more objects and the client application being configured to interpret and execute the scene;
determining a subset of the resources that the client application requires to perform the scene;
using the subset of resources on the client if the subset is available on the client;
loading the subset of resources from a second client if the subset is available on the second client; and
loading the subset of resources from the application server to the client if the subset is not available on the client or the second client.

8. The method of claim 7 wherein the client application is an interactive application.

9. The method of claim 7 wherein determining is performed by traversing an activity graph.

10. The method of claim 7 wherein the resources include assets, asset bags, scenes, graphics files, or audio files.

11. A method of distributing information from a server to a first client and a second client, the method comprising:
loading the information on a first client; and
distributing the information from the first client to a second client.

12. The method of claim 11 wherein the information includes an interactive software program.

13. The method of claim 12 further comprising the steps of:
determining the information that the interactive software program requires; and
retrieving the information that the interactive software program requires on an as needed basis.

14. The method of claim 13 wherein the information includes assets, asset bags, or scenes.

15. A method of performing a client application on a client, the method comprising:
defining a list of activities that the client application may be required to perform after a current activity, the list of activities requiring one or more resources;
determining whether the client has the resources available; and
fetching the resources if the client does not have the resources available.

16. The method of claim 15 wherein the resources include assets, asset bags, or scenes.

17. The method of claim 15 wherein the step of fetching is performed by requesting the resources from an application server.

18. The method of claim 15 wherein the step of fetching is performed by requesting the resources from one or more peer clients.

19. The methods of claim 15 wherein the client application is an interactive application.

20. A method of maintaining a knowledge base in a network environment, the method comprising:
maintaining a portion of a knowledge base on a client;
determining whether the client can access the knowledge base on an application server; and
updating the knowledge base on the application server when the application server is available.

21. The method of claim 20 wherein the knowledge base includes user information and status.

22. A method of providing an application, the method comprising:
downloading on a client a client application;
maintaining on a server a knowledge base, the knowledge base storing user-specific information;
downloading a portion of the knowledge base to the client; and
receiving updates to the knowledge base from the client.

23. The method of claim 22 wherein the knowledge base includes user-specific information.

24. The method of claim 22 wherein downloading the knowledge base includes downloading only a portion of the knowledge base corresponding to a user.

25. A computer program product for providing information, the computer program product having a medium with a computer program embodied thereon, the computer program comprising:
computer program code for receiving a client application, the client application requiring a plurality of resources to execute;
computer program code for determining a subset of the resources that the client application requires;
computer program code for retrieving the subset of the resources; and
computer program code for performing the client application with the subset of resources to provide information.

26. The computer program product of claim 25 wherein the resources include assets, asset bags, scenes, audio files, or graphics files.

27. The computer program product of claim 25 wherein the client application is an interactive application.

28. The computer program product of claim 25 wherein the computer program code for retrieving includes computer program code for retrieving the subset of assets from a peer client.

29. The computer program product of claim 25 wherein the computer program code retrieving includes computer program code for retrieving the subset of assets from an application server.

30. The computer program product of claim 25 wherein the computer program code for retrieving includes:
computer program code for requesting the subset of resources from one or more peer clients;
computer program code for determining a second subset of resources as the subset of resources that were not received from the one or more peer clients; and
computer program code for requesting the second subset of resources from the application server.

31. A computer program product for providing an interactive application on a client, the computer program product having a medium with a computer program embodied thereon, the computer program comprising:
computer program code for receiving from an application server a client application and a scene, the scene defining the interaction between one or more objects and the client application being configured to interpret and execute the scene;
computer program code for determining a subset of the resources that the client application requires to perform the scene;
computer program code for using the subset of resources on the client if the subset is available on the client;
computer program code for loading the subset of resources from a second client if the subset is available on the second client; and
computer program code for loading the subset of resources from the application server to the client if the subset is not available on the client or the second client.

32. The computer program product of claim 31 wherein the client application is an interactive application.

33. The computer program product of claim 31 wherein computer program code for determining is performed by traversing an activity graph.

34. The computer program product of claim 31 wherein the resources include assets, asset bags, scenes, graphics files, or audio files.

35. A computer program product for distributing information from a server to a first client and a second client, the computer program product having a medium with a computer program embodied thereon, the computer program comprising:
computer program code for loading the information on a first client; and
computer program code for distributing the information from the first client to a second client.

36. The computer program product of claim 35 wherein the information includes an interactive software program.

37. The computer program product of claim 36 further comprising:
computer program code for determining the information that the interactive software program requires; and
computer program code for retrieving the information that the interactive software program requires on an as needed basis.

38. The computer program product of claim 37 wherein the information includes assets, asset bags, or scenes.

39. A computer program product for performing a client application on a client, the computer program product having a medium with a computer program embodied thereon, the computer program comprising:
computer program code for defining a list of activities that the client application may be required to perform after a current activity, the list of activities requiring one or more resources;
computer program code for determining whether the client has the resources available; and
computer program code for fetching the resources if the client does not have the resources available.

40. The computer program product of claim 39 wherein the resources include assets, asset bags, or scenes.

41. The computer program product of claim 39 wherein the computer program code for fetching is performed by requesting the resources from an application server.

42. The computer program product of claim 39 wherein computer program code for fetching is performed by requesting the resources from one or more peer clients.

43. The computer program product of claim 39 wherein the client application is an interactive application.

44. A computer program product for maintaining a knowledge base in a network environment, the computer program product having a medium with a computer program embodied thereon, the computer program comprising:
computer program code for maintaining a portion of a knowledge base on a client;
computer program code for determining whether the client can access the knowledge base on an application server; and
computer program code for updating the knowledge base on the application server when the application server is available.

45. The computer program product of claim 44 wherein the knowledge base includes user information and status.

46. A computer program product for providing an application, the computer program product having a medium with a computer program embodied thereon, the computer program comprising
computer program code for downloading on a client a client application;
computer program code for maintaining on a server a knowledge base, the knowledge base storing user-specific information;
computer program code for downloading a portion of the knowledge base to the client; and
computer program code for receiving updates to the knowledge base from the client.

47. The computer program product of claim 46 wherein the knowledge base includes user-specific information.

48. The computer program product of claim 46 wherein computer program code for downloading the knowledge base includes computer program code for downloading only a portion of the knowledge base corresponding to a user.
